(19) United States
(12) Patent Application Publication
(10) Pub. No.: US 2019/0185594 A1
(43) Pub. Date: Jun. 20, 2019

(54) POLYETHYLENE FOR PIPES

(71) Applicant: NORNER VERDANDI AS, Stathelle (NO)

(72) Inventors: Tore Dreng, Stathelle (NO); Morten Lundquist, Stathelle (NO); Jarmo Lindroos, Stathelle (NO); Dermot O'Hare, Oxford (GB); Jean-Charles Buffet, Oxford (GB); Zoe Turner, Oxford (GB); Fraser Duncan, Oxford (GB)

(21) Appl. No.: 16/228,987

(22) Filed: Dec. 21, 2018

Related U.S. Application Data
(63) Continuation of application No. PCT/GB2017/051892, filed on Jun. 29, 2017.

(30) Foreign Application Priority Data
Jun. 29, 2016 (GB) 1611295.5

(51) Int. Cl. C08F 10/02; F16L 9/127

(52) U.S. Cl. CPC C08F 10/02; B29C 48/022; F16L 9/127

(57) ABSTRACT

The present invention provides a process for the preparation of a multimodal polyethylene, said multimodal polyethylene preferably having a bimodal or trimodal M.W. distribution, comprising: (i) polymerizing ethylene and optionally an α-olefin comonomer in a first polymerization stage to produce a first ethylene polymer; and (ii) polymerizing ethylene and optionally an α-olefin comonomer, in the presence of said first ethylene polymer, in a second polymerization stage, wherein said first and second polymerization stages are carried out in the presence of an unsupported metallocene catalyst, which is a complex of a group 4-10 metal having at least two ligands, wherein at least one of the ligands is persubstituted and comprises a delocalized pi system of electrons, each polymerization stage produces at least 5% wt of said multimodal polyethylene, and said multimodal polyethylene has a multimodal M.W. distribution, a M.W. of at least 50,000 g/mol and a bulk density of at least 250 g/dm³.

### INTRODUCTION

The present invention relates to a multistage polymerisation process for the preparation of a multimodal polyethylene, wherein at least the first and second polymerisation stages are carried out in the presence of an unsupported metallocene catalyst. The invention also relates to the multimodal polyethylene produced by the process which has a multimodal molecular weight distribution, a molecular weight of at least 50,000 g/mol and a bulk density of at least 250 g/dm³.

### BACKGROUND

Polyethylene (PE), and in particular high density polyethylene (HDPE), is the most commonly used material for the production of pipes. Polyethylene used for the manufacture of HDPE pipes needs to meet certain mechanical criteria, such as impact resistance, toughness and scratch resistance, as well as chemical requirements, e.g. resistance to corrosion. The pipes are often used at high inner pressures and subjected to external mechanical forces. Although the overall pressure is usually well below the yield stress of the polymer, mechanical failure almost always occurs before the polymer is chemically degraded. It is generally accepted that this is due to the existence of local heterogeneities of micrometer size in the polyethylene pipe causing a strong localized stress distribution around the flaws that exceeds the yield stress. Such a stress concentration induces the formation and growth of a craze by rupture of the craze fibrils. In this respect it is of high importance to use PE with as low local heterogeneities as possible. Normally these heterogeneities originate from supported catalysts where, especially when metallocene catalysts are concerned, silica or other related inorganic carriers are used.

Polyethylene pipes are particularly suited for non-conventional pipe installation due to their flexibility, deformability and availability in long lengths. The widespread use of modern relining techniques and fast pipe installation practices call for high material requirements and guarantees of performance, particularly with respect to the effect of scratches, notches, nicks and impingements that are inherent to these techniques and facilitates slow crack growth (SCG). When installing pipes by modern no-dig or trenchless installation methods (e.g. pipe bursting, horizontal direction drilling) the pipe is dragged horizontally through the ground. While often highly advantageous in that the surface of the ground, e.g. roads and other installations, need not be disturbed and the installation cost significantly reduced, on the other hand, the no-dig methods give the disadvantage of a high tendency for protruding stones, rocks etc. to scratch the outer surface of the pipe in the longitudinal direction. Furthermore, at the bottom of such longitudinal scratches, there will be a very high local tangential stress when pressure is applied inside the pipe. Thus, unfortunately, such scratches are very harmful since they often start cracks propagating through the wall that would otherwise never even have started.

These requirements on the performance level of pipes, in turn, mean that the polyethylene used for their production must meet certain requirements. Generally polyethylene used for pipe production has the following properties:

| Property | Units | Suitable range |
|---|---|---|
| Molecular weight (Mw) | g/mol | 100,000-500,000 |
| MFR₅ | g/10 min | 0.2-1.4 (EN12201) |
| Density | g/cm³ | 935-960 |

Commercially available polyethylene for pipe production is generally prepared either by using a chromium or a Ziegler Natta catalyst. Monomodal HDPE made in a single reactor with a chromium (Phillips) catalyst gives a relatively poor property profile with respect to demanding pressure pipe applications. HDPE pipe made using Ziegler Natta catalysts are usually prepared with two reactors operating in series; one reactor making a lower molecular weight homopolymer and one reactor making a higher molecular weight polymer containing comonomer which gives a better property profile compared to monomodal chromium HDPE. Ziegler Natta catalysts enable high molecular weight, high density polyethylene to be produced which provides the polyethylene with its required mechanical properties. The disadvantage of the use of Ziegler Natta catalysts, however, is that the polyethylene tends to have inhomogeneous comonomer incorporation.

Metallocene catalysts are attractive to use in polyethylene pipe production because they achieve much more homogeneous comonomer incorporation in the polymer compared to Ziegler Natta and chromium catalysts. Here, homogeneous comonomer incorporation means that comonomer is incorporated in similar quantities into polymer chains across the whole molecular weight range. In contrast with Ziegler Natta catalysts comonomer is typically incorporated only in polymer chains with certain molecular weight. The improved comonomer incorporation property with metallocenes will improve significantly, for example, slow crack growth and rapid crack propagation behaviour of the polymer which has crucial impact on the pipe properties.

Currently metallocene catalysts are exploited to a much lesser extent commercially for the production of polyethylene for pipe production than Ziegler Natta catalysts. When metallocene catalysts are employed in commercial scale processes, they tend to be used on external carriers or supports. The use of supports avoids the problems of reactor fouling, poor polymer morphology and low polymer bulk density which are typically encountered with the use of unsupported metallocenes. Supported metallocene catalysts, however, have relatively low activities and invariably yield polyethylene of relatively low molecular weight which means they are not suitable for pipe production. Due to the low polymerisation and/or catalyst activity, supported metallocene catalysts also yield polyethylene with high ash content and high gel content. As described above, due to local heterogeneities in the polymer structure high ash content and high gel content, often lead to mechanical failures in the pipe, meaning cracks and breakages. They also often affect the pipe appearance and performance by introducing roughness on the inner and outer surface which has an effect e.g. on the flowability of liquids. Also, high ash content has an effect on the electrical properties of the polymer leading to higher conductivity.

Silica is typically used as a carrier in supported metallocene catalysts and is often present in the final polymer. Silica is a hard material and scratches steel. Silica particles present in a polymer will scratch the metal surfaces of polymer melt handling equipment, e.g. extruders and dies, both in the polymer production plant as well as during subsequent melt forming into articles as the polymer flows along the metal surfaces, under a melt pressure of hundreds of bars. The continual scratching over time results in the polymer melt handling equipment eventually becoming damaged.

Also, the level of foreign, e.g. silica, particles in the produced polymer is extremely important because the amount of, e.g. catalyst, residues inside the polymer plays an important role in determining the applications where the polymer can be used. For example, electronics applications, optical media and pharmaceutical packaging all require a certain minimum level of residues in the polymer.

WO98/58001 discloses a process for the preparation of polyethylene for pipe production wherein a multistage polymerisation using a metallocene catalyst is carried out. Hydrogen is present in the first stage of the polymerisation but is entirely consumed therein so that the second stage polymerisation occurs in the absence of hydrogen. The first stage polymerisation produces a lower molecular weight polymer and the second stage polymerisation a higher molecular weight polymer.

WO98/58001 is focussed on the use of supported metallocene catalysts. It teaches that it is particularly desirable that the metallocene complex is supported on a solid substrate for use in the polymerisations. The preferred substrates are porous particulates such as inorganic oxides, e.g silica, alumina, silica-alumina, zirconia, inorganic halides or porous polymer particles. All of the examples in WO98/58001 employ supported metallocene catalysts.

WO98/58001 teaches that its process yields a polyethylene having a MFR₂ of 0.01 to 100 g/10 min, a weight average molecular weight of 30,000 to 500,000 g/mol, a melting point of 100-165° C. and a crystallinity of 20 to 70%. The examples of WO98/58001 illustrate the preparation of numerous polyethylenes. The MFR₂ values of the polymers produced is always greater than 1 g/10 min (c.f. the above 0.01 g/10 min minimum of the range) and in many cases is significantly greater with some examples producing polymers having MFR₂ values of 43 and 32 g/10 min. None of the polyethylenes produced in the examples of WO98/58001 have a MFR₂ of <0.1 g/10 min (MFR₅=0.2-0.5 g/10 min for pressure pipe) which is the ideal value for polyethylene pipe production. As shown in the examples section later, this is consistent with the Applicant's finding that it is not possible to produce polyethylene suitable for pipe production (i.e. high molecular weight and low MFR₂) using the supported catalyst illustrated in WO98/58001.

US2011/0091674 discloses multimodal copolymers of ethylene and their preparation in a multistage polymerisation process carried out in the presence of a metallocene catalyst. The catalyst is used in solid form, either on a particulate support such as silica, on solidified aluminoxane, or as solid particles prepared using emulsion solidification technology.

WO2013/113797 discloses a process for the production of multimodal polyethylene using a three stage polymerisation process. WO2013/113797 is focussed on the use of a Ziegler Natta catalyst system for the polymerisation process.

WO2013/091837 discloses bridged bis(indenyl) ligands, methods for their preparation, and their use in the preparation of metallocene complexes which may be used in the polymerisation of ethylene.

There is a need to develop a metallocene based polyethylene polymerisation process which proceeds with low reactor fouling and high activity and which yields a polyethylene suitable for pipe production. The polyethylene must have a high molecular weight, a low MFR₅, a high bulk density (indicating good particle morphology) and ideally a low ash and gel content.

### SUMMARY OF INVENTION

Viewed from a first aspect the present invention provides a process for the preparation of a multimodal polyethylene comprising:
polymerising ethylene and optionally an α-olefin comonomer in a first polymerisation stage to produce a first ethylene polymer; and
(ii) polymerising ethylene and optionally an α-olefin comonomer, in the presence of said first ethylene polymer, in a second polymerisation stage,
   wherein said first and second polymerisation stages are carried out in the presence of an unsupported metallocene catalyst, which is a complex of a group 4 to 10 metal having at least two ligands, wherein at least one of the ligands is persubstituted and comprises a delocalised pi system of electrons,
   and each polymerisation stage produces at least 5% wt of said multimodal polyethylene, and
   said multimodal polyethylene has a multimodal molecular weight distribution, a molecular weight of at least 50,000 g/mol and a bulk density of at least 250 g/dm³.

Viewed from a further aspect the present invention provides a multimodal polyethylene obtainable by a process as hereinbefore defined.

Viewed from a further aspect the present invention provides a multimodal polyethylene obtained by a process as hereinbefore defined.

Viewed from a further aspect the present invention provides a metallocene multimodal polyethylene comprising:
i) a multimodal molecular weight distribution;
ii) a molecular weight of at least 50,000 g/mol;
iii) a MFR₂ of less than 0.2 g/10 min;
iv) a MFR₅ of less than 1 g/10 min;
v) a bulk density of at least 250 g/dm³; and
vi) an ash content of less than 800 ppm wt.

Viewed from a further aspect the present invention provides a process for preparing a pipe comprising:
i) preparing a multimodal polyethylene by the process as hereinbefore defined; and
ii) extruding said multimodal polyethylene to produce pipe.

Viewed from a further aspect the present invention provides a pipe obtainable by a process as hereinbefore defined.

Viewed from a further aspect the present invention provides a pipe obtained by a process as hereinbefore defined.

Viewed from a further aspect the present invention provides a pipe comprising metallocene multimodal polyethylene as hereinbefore defined.

### Definitions

As used herein the term “polyethylene” refers to a polymer that comprises at least 50% wt, still more preferably at least 75% wt, still more preferably at least 85% wt and yet more preferably at least 90% wt units derived from ethylene.

As used herein the term “ethylene homopolymer” refers to a polymer which consists essentially of repeat units deriving from ethylene. Homopolymers may, for example, comprise at least 99% wt, preferably at least 99.5% wt, more preferably at least 99.9% wt and still more preferably at least 99.95% wt, e.g. 100% wt, of repeat units deriving from ethylene.

As used herein the term “ethylene copolymer” refers to a polymer comprising repeat units from ethylene and at least one other monomer. In typical copolymers at least 0.05% wt, more preferably at least 0.1% wt and still more preferably at least 0.4% wt of repeat units derive from at least one monomer other than ethylene. Typically ethylene copolymers will not comprise more than 15% by weight of repeat units deriving from monomers other than ethylene.

As used herein % wt is expressed relative to the weight of polyethylene unless otherwise specified.

As used herein the terms “lower” and “higher” are used relatively. Thus a lower molecular weight ethylene polymer has a lesser molecular weight than a higher molecular weight polymer.

As used herein the term LMW polymer refers to the lower molecular weight ethylene polymer.

As used herein the term HMW1 refers to the first higher molecular weight ethylene copolymer. As used herein the term HMW2 refers to the second higher molecular weight ethylene polymer. HMW1 and HMW2 each have higher molecular weights than the LMW polymer. Either of HMW1 or HMW2 may have the highest molecular weight or they may have the same molecular weight.

Whenever the term “molecular weight” is used, the weight average molecular weight (Mw) is meant unless otherwise specified.

As used herein the term “multimodal” refers to a polymer comprising a plurality of components or fractions, which have been produced under multistage polymerisation conditions resulting in different weight average molecular weights and molecular weight distributions for the components and/or in different comonomer contents. The prefix “multi” refers to the number of different components present in the polymer. Thus, for example, a polymer consisting of two components only is called “bimodal” and a polymer consisting of three components only is called “trimodal”.

As used herein the term “multimodal molecular weight distribution” refers to the form of the molecular weight distribution curve, i.e. the appearance of the graph of the polymer weight fraction as a function of its molecular weight. A polyethylene having a multimodal molecular weight distribution can show two or more maxima or at least be distinctly broadened in comparison with the curves for the individual components. In addition, multimodality may show as a difference in melting or crystallisation temperature curves of components. In contrast a polymer comprising one component produced under constant polymerisation conditions is referred to herein as unimodal.

As used herein the term “multimodal composition” refers to a composition comprising a plurality of components or fractions, which are each different in composition. Preferably the components or fractions each have a different constituent composition. Thus, for example, a composition comprising an ethylene homopolymer, an ethylene copolymer comprising 0.1% wt comonomer is a multimodal composition, specifically a bimodal composition.

As used herein, the term “multistage polymerisation” refers to a polymerisation which is carried out in two or more stages. Generally each stage is carried out in a separate reactor. The term multistage polymerisation is used interchangeably with multistep polymerisation.

As used herein the term “polymerisation stage” refers to a polymerisation step wherein the amount of polyethylene produced constitutes at least 1% wt and preferably at least 5% wt of the final multimodal polyethylene. Some polymerisations comprise a prepolymerisation stage wherein the polymerisation catalyst is polymerised with a relatively small amount of monomer. A prepolymerisation does not produce at least 1% wt and certainly does not produce at least 5% wt of the final polyethylene and is not considered herein to be a polymerisation stage.

As used herein the term catalyst system refers to the total active entity that catalyses the polymerisation reaction. Typically the catalyst system is a coordination catalyst system comprising a transition metal compound (the active site precursor) and an activator (sometimes referred to as a cocatalyst) that is able to activate the transition metal compound.

As used herein the term “metallocene catalyst” refers to a complex of a group 4-10 metal having at least two ligands wherein each of these ligands comprise a delocalised pi system of electrons.

As used herein the term “unsupported” refers to the absence of an external carrier. In other words the metallocene is not supported on or carried on another external carrier. Typical examples of supports are silica and alumina.

As used herein the term “slurry polymerisation” refers to a polymerisation wherein the polymer forms as a solid in a liquid. The liquid may be a monomer of the polymer. In the latter case the polymerisation is sometimes referred to as a bulk polymerisation. The term slurry polymerisation encompasses what is sometimes referred to in the art as supercritical polymerisation, i.e. a polymerisation wherein the polymer is a solid suspended in a fluid that is relatively close to its critical point, or if the fluid is a mixture, its pseudocritical point. A fluid may be considered relatively close to its critical point if its compressibility factor is less than double its critical compressibility factor or, in the case of a mixture, its pseudocritical compressibility factor.

As used herein the term “hydrocarbyl group” covers any group comprising carbon and hydrogen only. An example of such a group is an aliphatic moiety. The hydrocarbyl group may, for example, comprise 1, 2, 3, 4, 5, 6, 7, 8, 9, 10, 11 or 12 carbon atoms. Examples of hydrocarbyl groups include C₁₋₆ alkyl (e.g. C₁, C₂, C₃ or C₄ alkyl, for example methyl, ethyl, propyl, isopropyl, n-butyl, sec-butyl or tert-butyl); alkenyl (e.g. 2-butenyl); and alkynyl (e.g. 2-butynyl).

As used herein the term “carbocyclyl” refers to a saturated (e.g. cycloalkyl) or unsaturated (e.g. aryl) ring moiety having 3, 4, 5, 6, 7, 8, 9 or 10 ring carbon atoms. In particular, carbocyclyl includes a 3 to 10-membered ring or ring system and, in particular, a 6-membered ring, which may be saturated or unsaturated. Examples of carbocyclic groups include cyclopropyl, cyclobutyl, cyclopentyl, cyclohexyl, norbornyl, bicyclo[2.2.2]octyl, phenyl and naphthyl.

As used herein the term “heterocyclyl” refers to a saturated (e.g. heterocycloalkyl) or unsaturated (e.g. heteroaryl) heterocyclic ring moiety having from 3, 4, 5, 6, 7, 8, 9 or 10 ring atoms, at least one of which is selected from nitrogen, oxygen, phosphorus, silicon and sulphur. Preferably, heterocyclyl includes a 3- to 10-membered ring or ring system and more particularly a 5- or 6-membered ring, which may be saturated or unsaturated.

Examples of heterocyclyl groups include oxiranyl, azirinyl, 1,2-oxathiolanyl, imidazolyl, thienyl, furyl, tetrahydrofuryl, pyranyl, thiopyranyl, thianthrenyl, isobenzofuranyl, benzofuranyl, chromenyl, 2-pyrrolyl, pyrrolyl, pyrrolinyl, pyrrolidinyl, imidazolyl, imidazolidinyl, benzimidazolyl, pyrazolyl, pyrazinyl, pyrazolidinyl, thiazolyl, isothiazolyl, dithiazolyl, oxazolyl, isoxazolyl, pyridyl, pyrazinyl, pyrimidinyl, piperidyl, piperazinyl, pyridazinyl, morpholinyl, thiomorpholinyl, especially thiomorpholino, indolizinyl, isoindolyl, 3-indolyl, indolyl, benzimidazolyl, cumaryl, indazolyl, triazolyl, tetrazolyl, purinyl, 4H-quinolizinyl, isoquinolyl, quinolyl, tetrahydroquinolyl, tetrahydroisoquinolyl, decahydroquinolyl, octahydroisoquinolyl, benzofuranyl, dibenzofuranyl, benzothiophenyl, di benzothiophenyl, phthalazinyl, naphthyridinyl, quinoxalyl, quinazolinyl, quinazolinyl, cinnolinyl, pteridinyl, carbazolyl, β-carbolinyl, phenanthridinyl, acridinyl, perimidinyl, phenanthrolinyl, furazanyl, phenazinyl, phenothiazinyl, phenoxazinyl, chromenyl, isochromanyl and chromanyl.

As used herein the term “halogen” encompasses atoms selected from the group consisting of F, Cl, Br and I.

As used herein the term “alkyl” refers to saturated, straight chained, branched or cyclic groups. Alkyl groups may be substituted or unsubstituted. Preferably alkyl groups have 1, 2, 3, 4, 5 or 6 carbon atoms and more preferably 1, 2, 3 or 4 carbon atoms. This term includes groups such as methyl, ethyl, propyl (n-propyl or isopropyl), butyl (n-butyl, sec-butyl or tert-butyl), pentyl, hexyl.

As used herein the term “alkenyl” refers to straight chained, branched or cyclic group comprising a double bond. Alkenyl groups may be substituted or unsubstituted.

As used herein the term “alkynyl” refers to straight chained, branched or cyclic groups comprising a triple bond. Alkynyl groups may be substituted or unsubstituted.

As used herein the term “cycloalkyl” refers to a saturated or partially saturated mono- or bicyclic alkyl ring system containing 3 to 10 carbon atoms. Cycloalkyl groups may be substituted or unsubstituted. Preferred cycloalkyl groups have 3, 4, 5, 6, 7 or 8 carbon atoms. The group may be a bridged or polycyclic ring system. Preferred cycloalkyl groups are monocyclic. Examples of cycloalkyl groups include cyclopropyl, cyclobutyl, cyclopentyl, cyclohexyl, norbornyl and bicyclo[2.2.2]octyl.

As used herein the term “alkoxy” refers to O-alkyl groups, wherein alkyl is as defined above. Alkoxy groups may include 1, 2, 3, 4, 5 or 6 carbon atoms and more preferably 1, 2 3 or 4 carbon atoms. This term includes groups such as methoxy, ethoxy, propoxy, isopropoxy, butoxy, tert-butoxy, pentoxy and hexoxy.

As used herein the term “haloalkyl” refers to saturated, straight chained, branched or cyclic groups in which one or more hydrogen atoms are replaced by a halo atom, e.g. F or Cl, especially F.

As used herein the term “aryl” refers to a group comprising at least one aromatic ring. The term aryl encompasses heteroaryl as well as fused ring systems wherein one or more aromatic ring is fused to a cycloalkyl ring. Aryl groups may be substituted or unsubstituted. Preferred aryl groups comprise 6, 7, 8, 9 or 10 ring carbon atoms. Preferably aryl is phenyl.

As used herein the term “arylalkyl” or “aralkyl” refers to an alkyl group as hereinbefore defined that is substituted with an aryl group as hereinbefore defined.

As used herein the term “arylalkenyl” refers to an alkenyl group as hereinbefore described that is substituted with an aryl group as hereinbefore defined.

As used herein the term “aryloxy” refers to O-aryl groups, wherein aryl is as defined above.

As used herein the term “arylalkoxy” refers to O-arylalkyl groups, wherein arylalkyl is as defined above.

As used herein the term “heteroaryl” refers to a group comprising at least one aromatic ring in which one or more ring carbon atoms are replaced by at least one hetero atom such as —O—, —N— or —S—. Preferred heteroaryl groups comprise 5, 6, 7, 8, 9 or 10 ring atoms, at least one of which is selected from nitrogen, oxygen and sulphur. The group may be a polycyclic ring system, having two or more rings, at least one of which is aromatic, but is more preferably monocyclic. Examples of heteroaryl groups include pyrimidinyl, furanyl, benzo[b]thiophenyl, thiophenyl, pyrrolyl, imidazolyl, pyrrolidinyl, pyridinyl, benzo[b]furanyl, pyrazinyl, purinyl, indolyl, benzimidazolyl, quinolinyl, phenothiazinyl, triazinyl, phthalazinyl, 2H-chromenyl, oxazolyl, isoxazolyl, thiazolyl, isoindolyl, indazolyl, purinyl, isoquinolinyl, quinazolinyl and pteridinyl.

As used herein the term “substituted” refers to a group wherein one or more, especially up to 6, more especially 1, 2, 3, 4, 5 or 6, of the hydrogen atoms in the group are replaced independently of each other by the corresponding number of the described substituents. The term “optionally substituted” as used herein means substituted or unsubstituted.

As used herein the term “persubstituted” refers to a group wherein all of the hydrogen atoms in the group are replaced independently of each other by the corresponding number of the described substituents, e.g. alkyl groups. A preferred form of persubstitution is peralkylation.

Optional substituents that may be present on alkyl, cycloalkyl, alkenyl and alkynyl groups as well as the alkyl or alkenyl moiety of an arylalkyl or arylalkenyl group respectively include amino, nitro, cyano, (1-16C)alkylamino, [(1-16C)alkyl]₂amino, —S(O)ᵣ(1-16C)alkyl (where r is 0, 1 or 2), C₁₋₁₆ alkyl or C₁₋₁₆ cycloalkyl wherein one or more non-adjacent C atoms may be replaced with O, S, N, C═O and —COO—, substituted or unsubstituted C₅₋₁₄ aryl, substituted or unsubstituted C₅₋₁₄ heteroaryl, C₁₋₁₆ alkoxy, C₁₋₁₆ alkylthio, halo, e.g. fluorine and chlorine, cyano and arylalkyl. Preferred substituents, e.g. present on R¹-R¹⁶ groups, are halo, amino, nitro, cyano, (1-6C)alkyl, (1-6C)alkoxy, (1-6C)alkylamino, [(1-6C)alkyl]₂amino or —S(O)ᵣ(1-6C)alkyl (where r is 0, 1 or 2).

Some metallocenes of the present invention may be present as meso or rac isomers, and the present invention includes both such isomeric forms. A person skilled in the art will appreciate that a mixture of isomers of the compound of the present invention may be used for catalysis applications, or the isomers may be separated and used individually (using techniques well known in the art, such as, for example, fractional crystallization). If the structure of a compound of formula (I) is such that rac and meso isomers do exist, the compound may be present in the rac form only, or in the meso form only.

### DETAILED DESCRIPTION OF INVENTION

The process of the present invention is a multistage polymerisation process, wherein ethylene and optionally an α-olefin comonomer, is polymerised in a first polymerisation stage to produce a first ethylene polymer and then, in the presence of the first ethylene polymer, a second polymerisation stage with ethylene and optionally an α-olefin comonomer is carried out. The first and second polymerisation stages are both carried out with an unsupported metallocene catalyst. Advantageously no reactor fouling occurs, the activity of the unsupported catalyst is high and the overall activity of the polymerisations is high. The multimodal polyethylene obtained by the process of the present invention has a multimodal molecular weight distribution, a surprisingly high molecular weight (Mw) of at least 50,000 g/mol and a bulk density, reflecting good particle morphology, of at least 250 g/dm³. The multimodal polyethylene is therefore suitable for extrusion to form pipes.

### Metallocene Catalyst

The process of the present invention employs an unsupported metallocene catalyst. Thus the metallocene catalysts of the present invention do not include a carrier such as silica or alumina. The absence of a support brings a number of advantages including higher catalytic activity per mol of metal compared to supported catalysts and higher catalytic productivity. The unsupported metallocene catalyst employed in the process of the invention unexpectedly produces multimodal polyethylene with low ash content and low gels compared to the corresponding supported metallocene catalyst under the same conditions. The unsupported metallocene catalyst employed in the process of the invention also produces multimodal polyethylene of relatively high molecular weight, high MFR_{2/5} and high bulk density. Advantageously the multimodal polyethylene obtained in the process is suitable for the production of pipes.

The metallocene catalyst is a complex of a group 4 to 10 metal having at least two ligands, wherein at least one of the ligands is persubstituted and comprises a delocalised pi system of electrons. Preferably the persubstituted ligand comprises a cyclopentadienyl group. The ligand may be, for example, persubstituted cyclopentadienyl, persubstituted indenyl, persubstituted pentalenyl, persubstituted hydropentalenyl or persubstituted fluorenyl. Still more preferably the persubstituted ligand is selected from the ligands shown below:

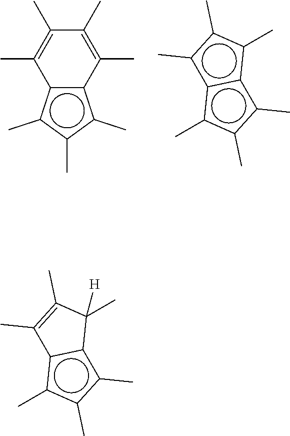

Metallocenes comprising persubstituted indenyl and/or persubstituted pentalenyl and/or persubstituted hydropentalenyl are particularly preferred.

In preferred metallocenes for use in the process of the invention, two ligands are present, optionally joined by a bridging group. The substitution pattern on the two ligands may be the same or different. The metallocenes employed in the present invention may be symmetrical or asymmetrical.

The metallocene preferably comprises at least one metal ion of group 4 to 10, more preferably group 4 to 6 and still more preferably group 4. The metal ion is η- bonded to the pi electrons of the ligands. Preferred metal ions are formed by a metal selected from Zr, Hf or Ti, more preferably Zr or Hf and still more preferably Zr.

Preferred metallocenes are of formula (I):

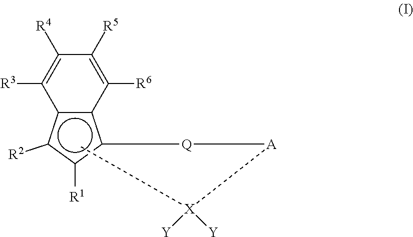

wherein
R¹, R², R³, R⁴, R⁵ and R⁶ are each independently selected from substituted or unsubstituted, preferably unsubstituted, hydrocarbyl, carbocyclyl or heterocyclyl;
Q is a bridging group;
X is selected from Zr, Ti or Hf;
each Y is selected from halo, hydride, a phosphonated, sulfonated or borate anion, or a substituted or unsubstituted (1-6C)alkyl, (2-6C)alkenyl, (2-6C)alkynyl, (1-6C)alkoxy, aryl, aryl(1-4C)alkyl or aryloxy, or both Y groups are (1-3C)alkylene groups joined at their respective ends to a group Q such that when taken with X and Q, the two Y groups form a 4, 5 or 6 membered ring; and
A is NR′, wherein R′ is (1-6alkyl), (2-6C)alkenyl, (2-6C)alkynyl, (1-6C)alkoxy, aryl, aryl(1-4C)alkyl or aryloxy, or Cp, where Cp is a cyclic group having a delocalised system of pi electrons.

In some preferred metallocenes of formula (I), each of R¹, R², R³, R⁴, R⁵ and R⁶ is independently selected from hydrocarbyl or carbocyclyl and preferably from hydrocarbyl or aryl. More preferably each of R¹, R², R³, R⁴, R⁵ and R⁶ is independently selected from (1-6C)alkyl or phenyl. Still more preferably each of R¹, R², R³, R⁴, R⁵ and R⁶ is a (1-6C)alkyl.

In further preferred metallocenes of formula (I) each of R¹, R², R³, R⁴, R⁵ and R⁶ is independently (1-6C)alkyl, more preferably (1-4C)alkyl and still more preferably (1-2C)alkyl. In particularly preferred metallocenes of formula (I) each of R¹ and R² is independently (1-4C)alkyl and each of R³, R⁴, R⁵ and R⁶ is methyl. In especially preferred metallocenes of formula (I) R² is methyl or ethyl and each of R¹, R³, R⁴, R⁵ and R⁶ is methyl.

In preferred metallocenes of formula (I) Q is a bridging group comprising 1, 2 or 3 atoms selected from C, N, O, S, Ge, Sn, P, B or Si, or a combination thereof. In some preferred metallocenes of formula (I) Q is a bridging group comprising 1, 2 or 3 atoms selected from C, B, or Si, or a combination thereof, and still more preferably Q is a bridging group comprising 1 or 2 atoms selected from C and Si. Optionally the bridging group is substituted with one or more groups selected from hydroxyl, (1-6C)alkyl, (2-6C)alkenyl, (2-6C)alkynyl, (1-6C)alkoxy and aryl groups.

In further preferred metallocenes of formula (I) Q is a bridging group selected from —[C(Rₐ)(R_{b})—C(R_{c})(R_{d})]— and —[Si(Rₑ)(R_{f})]—, wherein Rₐ, R_{b}, R_{c}, R_{d}, Rₑ and R_{f} are independently selected from hydrogen, hydroxyl, (1-6C)alkyl, (2-6C)alkenyl, (2-6C)alkynyl, (1-6C)alkoxy and aryl. Preferably Rₐ, R_{b}, R_{c} and R_{d} are each hydrogen. Preferably Rₑ and R_{f} are each independently (1-6C)alkyl, (2-6C)alkenyl or phenyl. Still more preferably Rₑ and R_{f} are each independently (1-4C)alkyl, (2-4C)alkenyl or phenyl.

In further preferred metallocenes of formula (I), Q is a bridging group having the formula —[Si(Re)(Rf)]—, wherein Rₑ and R_{f} are each independently selected from methyl, ethyl, propyl, allyl or phenyl, more preferably methyl, ethyl, propyl and allyl and still more preferably Rₑ and R_{f} are each methyl.

In further preferred metallocenes of formula (I), Q is a bridging group having the formula —[C(RₐR_{b})]ₙ— wherein n is 2 or 3 and Rₐ and R_{b} are each independently hydrogen, (1-6C)alkyl or (1-6C)alkoxy. More preferably Q is —CH₂—CH₂— or —CH₂—CH₂—CH₂—, and yet more preferably —CH₂—CH₂—.

In further preferred metallocenes of formula (I), X is selected from Zr, Ti, Hf and more preferably Zr or Ti. In some preferred metallocenes of formula (I) X is Zr. In other preferred metallocenes of formula (I) X is Ti.

In further preferred metallocenes of formula (I), each Y group is the same. Preferably Y is selected from halo (e.g. Cl, Br, F), (1-6C)alkyl or phenyl and more preferably halo (e.g. Cl, Br, F) or (1-6C)alkyl. Optionally the (1-6C)alkyl or phenyl group is substituted with halo (e.g. Cl, Br, F), nitro, amino, phenyl, benzyl, (1-6C)alkoxy, aryloxy, or Si[(1-4C)alkyl]₃. In further preferred metallocenes of formula (I), each Y is selected from chloro, bromo or methyl and more preferably chloro or bromo. Particularly preferably each Y is chloro.

In further preferred metallocenes of formula (I), A is Cp, wherein Cp is a cyclic group having a delocalised system of pi electrons. Cp is preferably an unsubstituted or substituted ligand comprising at least one cyclopentadienyl group. Preferred metallocenes are of formula (II):

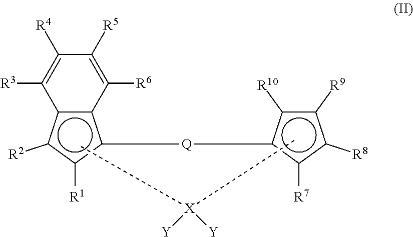

wherein R¹, R², R³, R⁴, R⁵ and R⁶, Q, X and Y are as defined in relation to formula (I);
R⁷ and R⁸ are each independently H, substituted or unsubstituted, preferably unsubstituted, hydrocarbyl, carbocyclyl or heterocyclyl, or R⁷ and R⁸ are linked such that, when taken in combination with the atoms to which they are attached, they form a substituted or unsubstituted 6-membered fused aromatic ring;
R⁹ and R¹⁰ are each independently H, substituted or unsubstituted, preferably unsubstituted, hydrocarbyl, carbocyclyl or heterocyclyl, or R⁹ and R¹⁰ are linked such that, when taken in combination with the atoms to which they are attached, they form a substituted or unsubstituted 6-membered fused aromatic ring.

In preferred metallocenes of formula (II), preferred R¹, R², R³, R⁴, R⁵, R⁶, Q, and Y are the same as those set out above in relation to formula (I).

In preferred metallocenes of formula (II), R⁷ and R⁸ are H, substituted or unsubstituted, preferably unsubstituted, hydrocarbyl, carbocyclyl or heterocyclyl. In further preferred metallocenes of formula (II), each of R⁷ and R⁸ is independently selected from H, hydrocarbyl or carbocyclyl and preferably from H, hydrocarbyl or aryl. More preferably each of R⁷ and R⁸ is independently selected from H, (1-6C)alkyl or phenyl. Still more preferably each of R⁷ and R⁸ is H or a (1-6C)alkyl.

In further preferred metallocenes of formula (II) each of R⁷ and R⁸ is independently H or (1-6C)alkyl, more preferably (1-4C)alkyl and still more preferably (1-2C)alkyl. In particularly preferred metallocenes of formula (II) each of R⁷ and R⁸ is H or (1-4C)alkyl.

In especially preferred metallocenes of formula (II) R⁸ is methyl or ethyl and R⁷ is methyl or vice versa, R⁸ is methyl and R⁷ is H or vice versa or R⁷ and R⁸ are both H.

In particularly preferred metallocenes of formula (II), R⁷ is the same as R¹. In other particularly preferred metallocenes of formula (II), R⁸ is the same as R². Especially preferably, R⁷ is the same as R¹ and R⁸ is the same as R².

In one group of preferred metallocenes of formula (II), R⁹ and R¹⁰ are linked such that, when taken in combination with the atoms to which they are attached, they form a substituted or unsubstituted 6-membered fused aromatic ring. These metallocenes have symmetrical core structures. Preferred metallocenes are of formula (IIa):

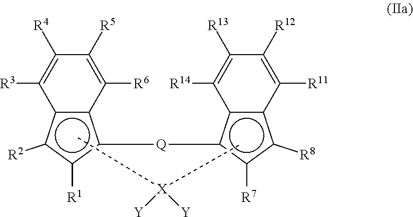

wherein
R¹, R², R³, R⁴, R⁵ and R⁶, Q, X and Y are as defined in relation to formula (I);
R⁷ and R⁸ are each independently selected from H, substituted or unsubstituted, preferably unsubstituted, hydrocarbyl, carbocyclyl or heterocyclyl;
R¹¹, R¹², R¹³ and R¹⁴ are each independently selected from H, substituted or unsubstituted, preferably unsubstituted, hydrocarbyl, carbocyclyl or heterocyclyl.

In preferred metallocenes of formula (IIa), preferred R¹, R², R³, R⁴, R⁵, R⁶, Q, X and Y are the same as those set out above in relation to formula (I).

In preferred metallocenes of formula (IIa), preferred R⁷ and R⁸ are the same as those set out above in relation to formula (II).

In preferred metallocenes of formula (IIa), R¹¹, R¹², R¹³ and R¹⁴ are substituted or unsubstituted, preferably unsubstituted, hydrocarbyl, carbocyclyl or heterocyclyl. In preferred metallocenes of formula (IIa), each of R¹¹, R¹², R¹³ and R¹⁴ is independently selected from hydrocarbyl or carbocyclyl and preferably from hydrocarbyl or aryl. More preferably each of R¹¹, R¹², R¹³ and R¹⁴ is independently selected from (1-6C)alkyl or phenyl. Still more preferably each of R¹¹, R¹², R¹³ and R¹⁴ is a (1-6C)alkyl.

In further preferred metallocenes of formula (IIa) each of R¹¹, R¹², R¹³ and R¹⁴ is independently (1-6C)alkyl, more preferably (1-4C)alkyl and still more preferably (1-2C)alkyl. In particularly preferred metallocenes of formula (IIa) each of R¹¹, R¹², R¹³ and R¹⁴ is independently methyl.

In particularly preferred metallocenes of formula (IIa), R¹¹ is the same as R³. In other particularly preferred metallocenes of formula (IIa), R¹² is the same as R⁴. In other particularly preferred metallocenes of formula (IIa), R¹³ is the same as R⁵. In other particularly preferred metallocenes of formula (IIa), R¹⁴ is the same as R⁶. Especially preferably, R³-R⁶ and R¹¹-R¹⁴ are the same. Still more preferably each of R¹-R¹⁴ is methyl.

Still further preferred metallocenes are those of formulae (IIIa) and (IIIb):

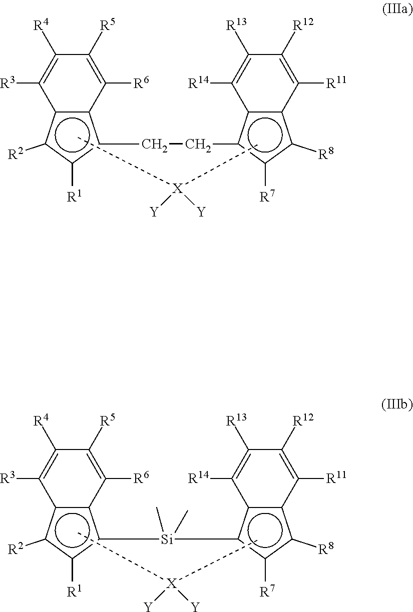

wherein
R¹, R², R³, R⁴, R⁵, R⁶, X and Y are as defined in relation to formula (I); and
R⁷, R⁸, R¹¹, R¹², R¹³ and R¹⁴ are as defined in relation to formula (IIa).

Still further preferred metallocenes are those of formulae (IVa) and (IVb):

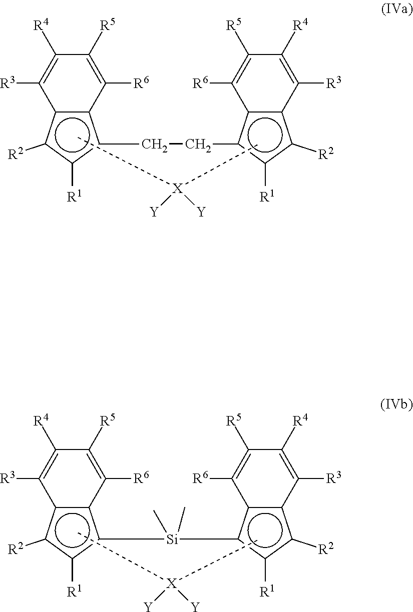

wherein
R¹, R², R³, R⁴, R⁵, R⁶, X and Y are as defined in relation to formula (I).

In particularly preferred metallocenes of formulae (IIIa), (IIIb), (IVa) and (IVb), each of R¹, R², R³, R⁴, R⁵ and R⁶ is independently selected from a hydrocarbyl or a carbocyclyl and preferably from hydrocarbyl or aryl. More preferably each of R¹, R², R³, R⁴, R⁵ and R⁶ is independently selected from (1-6C)alkyl or phenyl. Still more preferably each of R¹, R², R³, R⁴, R⁵ and R⁶ is independently (1-6C)alkyl.

In further preferred metallocenes of formulae (IIIa), (IIIb), (IVa) and (IVb), each of R¹, R², R³, R⁴, R⁵ and R⁶ is independently (1-6C)alkyl, more preferably (1-4C)alkyl and still more preferably (1-2C)alkyl. In particularly preferred metallocenes of formulae (IIIa), (IIIb), (IVa) and (IVb), each of R¹ and R² is (1-4C)alkyl and each of R³, R⁴, R⁵ and R⁶ is methyl. In especially preferred metallocenes of formulae (IIIa), (IIIb), (IVa) and (IVb), R² is methyl or ethyl and each of R¹, R³, R⁴, R⁵ and R⁶ is methyl.

In particularly preferred metallocenes of formulae (IIIa) and (IIIb), each of R⁷, R⁸, R¹¹, R¹², R¹³ and R¹⁴ is independently selected from hydrocarbyl or carbocyclyl and preferably from hydrocarbyl or aryl. More preferably each of R⁷, R⁸, R¹¹, R¹², R¹³ and R¹⁴ is independently selected from (1-6C)alkyl or phenyl. Still more preferably each of R⁷, R⁸, R¹¹, R¹², R¹³ and R¹⁴ is a (1-6C)alkyl.

In further preferred metallocenes of formulae (IIIa) and (IIIb), each of R⁷, R⁸, R¹¹, R¹², R¹³ and R¹⁴ is independently (1-6C)alkyl, more preferably (1-4C)alkyl and still more preferably (1-2C)alkyl. In particularly preferred metallocenes of formulae (IIIa) and (IIIb), each of R⁷, R⁸, R¹¹, R¹², R¹³ and R¹⁴ is (1-4C)alkyl and preferably methyl.

In particularly preferred metallocenes of formulae (IIIa), (IIIb), (IVa) and (IVb), X is preferably selected from Zr, Ti, Hf and more preferably Zr or Ti. In some preferred metallocenes of formulae (IIIa), (IIIb), (IVa) and (IVb) X is Zr.

In particularly preferred metallocenes of formulae (IIIa), (IIIb), (IVa) and (IVb), each Y group is the same. Preferably Y is selected from halo (e.g. Cl, Br, F), (1-6C)alkyl or phenyl and more preferably halo (e.g. Cl, Br, F) or (1-6C)alkyl. Optionally the (1-6C)alkyl or phenyl group is substituted with halo (e.g. Cl, Br, F), nitro, amino, phenyl, benzyl, (1-6C)alkoxy, aryloxy, or Si[(1-4C)alkyl]₃. In further preferred metallocenes of formulae (IIIa), (IIIb), (IVa) and (IVb) each Y is selected from chloro, bromo or methyl and more preferably chloro or bromo. Particularly preferably each Y is chloro.

Further preferred metallocenes are those of formula (Va):

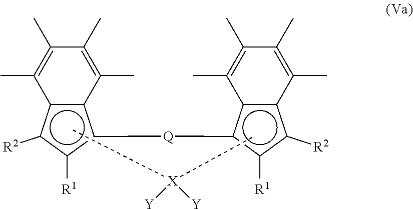

wherein
R¹, R², Q, X and Y are as defined in relation to formula (I).

Yet further preferred metallocenes are those of formula (Vb):

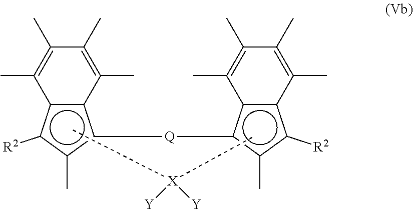

wherein
R², Q, X and Y are as defined in relation to formula (I).

In particularly preferred metallocenes of formula (Va) R¹ is independently selected from hydrocarbyl or carbocyclyl and preferably from hydrocarbyl or aryl. More preferably R¹ is independently selected from (1-6C)alkyl or phenyl. Still more preferably R¹ is a (1-6C)alkyl.

In further preferred metallocenes of formula (Va), R¹ is independently (1-6C)alkyl, more preferably (1-4C)alkyl and still more preferably (1-2C)alkyl. In particularly preferred metallocenes of formula (Va), R¹ is (1-4C)alkyl. In especially preferred metallocenes of formula (Va), R¹ is methyl or ethyl and especially methyl.

In particularly preferred metallocenes of formula (Va) and (Vb), R² is independently selected from hydrocarbyl or carbocyclyl and preferably from hydrocarbyl or aryl. More preferably R² is independently selected from (1-6C)alkyl or phenyl. Still more preferably R² is a (1-6C)alkyl.

In further preferred metallocenes of formulae (Va) and (Vb), R² is independently (1-6C)alkyl, more preferably (1-4C)alkyl and still more preferably (1-2C)alkyl. In particularly preferred metallocenes of formulae (Va) and (Vb), R² is (1-4C)alkyl. In especially preferred metallocenes of formulae (Va) and (Vb), R² is methyl or ethyl and especially methyl.

In further preferred metallocenes of formulae (Va) and (Vb) Q is a bridging group selected from —[C(Rₐ)(R_{b})—C(R_{c})(R_{d})]— and —[Si(Rₑ)(R_{f})]—, wherein Rₐ, R_{b}, R_{c}, R_{d}, Rₑ and R_{f} are independently selected from hydrogen, hydroxyl, (1-6C)alkyl, (2-6C)alkenyl, (2-6C)alkynyl, (1-6C)alkoxy and aryl. Preferably Rₐ, R_{b}, R_{c} and R_{d} are each hydrogen. Preferably Rₑ and R_{f} are each independently (1-6C)alkyl, (2-6C)alkenyl or phenyl. Still more preferably Rₑ and R_{f} are each independently (1-4C)alkyl, (2-4C)alkenyl or phenyl.

In further preferred metallocenes of formulae (Va) and (Vb), Q is a bridging group having the formula —[Si(Rₑ)(R_{f})]—, wherein Rₑ and R_{f} are each independently selected from methyl, ethyl, propyl, allyl or phenyl, more preferably methyl, ethyl, propyl and allyl and still more preferably Rₑ and R_{f} are each methyl.

In other preferred metallocenes of formulae (Va) and (Vb), Q is a bridging group having the formula —[C(RₐR_{b})]ₙ— wherein n is 2 or 3 and Rₐ and R_{b} are each independently hydrogen, (1-6C)alkyl or (1-6C)alkoxy. More preferably Q is —CH₂—CH₂— or —CH₂—CH₂—CH₂—, and yet more preferably —CH₂—CH₂—.

In particularly preferred metallocenes of formulae (Va) and (Vb), X is preferably selected from Zr, Ti, Hf and more preferably Zr or Ti. In some preferred metallocenes of formulae (Va) and (Vb) X is Zr.

In particularly preferred metallocenes of formulae (Va) and (Vb), each Y group is the same. Preferably Y is selected from halo (e.g. Cl, Br, F), (1-6C)alkyl or phenyl and more preferably halo (e.g. Cl, Br, F) or (1-6C)alkyl. Optionally the (1-6C)alkyl or phenyl group is substituted with halo (e.g. Cl, Br, F), nitro, amino, phenyl, benzyl, (1-6C)alkoxy, aryloxy, or Si[(1-4C)alkyl]₃. In further preferred metallocenes of formulae (Va) and (Vb), each Y is selected from chloro, bromo or methyl and more preferably chloro or bromo. Particularly preferably each Y is chloro.

Still further preferred metallocenes are those of formula (VIa) and (VIb):

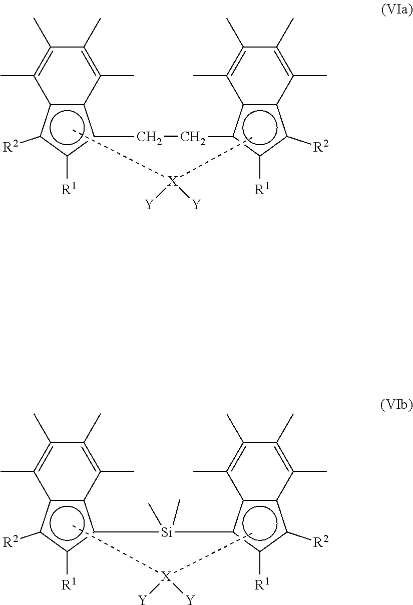

wherein
R¹, R², X and Y are as defined in relation to formula (I).

In particularly preferred metallocenes of formulae (VIa) and (VIb) R¹ and R² are independently selected from hydrocarbyl or carbocyclyl and preferably from hydrocarbyl or aryl. More preferably R¹ and R² are independently selected from (1-6C)alkyl or phenyl. Still more preferably R¹ and R² are independently (1-6C)alkyl.

In further preferred metallocenes of formulae (VIa) and (VIb), R¹ and R² are independently (1-6C)alkyl, more preferably (1-4C)alkyl and still more preferably (1-2C)alkyl. In particularly preferred metallocenes of formulae (VIa) and (VIb), R¹ and R² are (1-4C)alkyl. In especially preferred metallocenes of formulae (VIa) and (VIb), R¹ and R² are methyl or ethyl and especially methyl.

In particularly preferred metallocenes of formulae (VIa) and (VIb), X is preferably selected from Zr, Ti, Hf and more preferably Zr or Ti. In some preferred metallocenes of formula (VIa) and (VIb) X is Zr.

In particularly preferred metallocenes of formulae (VIa) and (VIb), each Y group is the same. Preferably Y is selected from halo (e.g. Cl, Br, F), (1-6C)alkyl or phenyl and more preferably halo (e.g. Cl, Br, F) or (1-6C)alkyl. Optionally the (1-6C)alkyl or phenyl group is substituted with halo (e.g. Cl, Br, F), nitro, amino, phenyl, benzyl, (1-6C)alkoxy, aryloxy, or Si[(1-4C)alkyl]₃. In further preferred metallocenes of formula (VIa) and (VIb), each Y is selected from chloro, bromo or methyl and more preferably chloro or bromo. Particularly preferably each Y is chloro.

Two particularly preferred metallocenes are shown below:

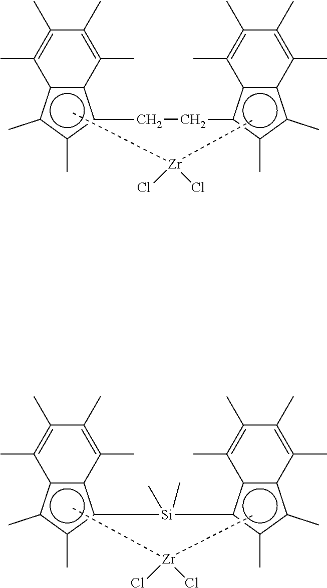

Another group of preferred metallocenes of formula (II) are those wherein:

R⁷, R⁸, R⁹ and R¹⁰ are each independently H, substituted or unsubstituted, preferably unsubstituted, hydrocarbyl, carbocyclyl or heterocyclyl; or
R⁷ and R⁸ as well as R⁹ and R¹⁰ are each independently linked such that, when taken in combination with the atoms to which they are attached, they each form a substituted or unsubstituted 6-membered fused aromatic ring.

Further preferred metallocenes are those of formulae (VIIa) and (VIIb):

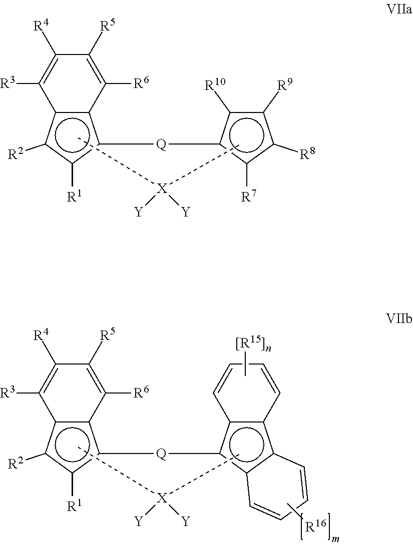

wherein
R¹, R², R³, R⁴, R⁵, R⁶, Q, X and Y are as defined in relation to formula (I);
R⁷, R⁸, R⁹ and R¹⁰ are each independently H, substituted or unsubstituted, preferably unsubstituted, hydrocarbyl, carbocyclyl or heterocyclyl;
R¹⁵ and R¹⁶ are each independently selected from hydrogen, (1-4C)alkyl and phenyl, wherein the alkyl and phenyl are optionally substituted with one or more groups selected from (1-4C)alkyl, (2-4C)alkenyl, (2-4C)alkynyl, (1-4C)alkoxy, halo, amino and nitro; and
each of n and m is independently 0, 1 or 2.

In preferred metallocenes of formulae (VIIa) and (VIIb), preferred R¹, R², R³, R⁴, R⁵, R⁶, Q, X and Y are the same as those set out above in relation to formula (I).

In preferred metallocenes of formula (VIIa), preferred R⁷, R⁸, R⁹ and R¹⁰ are H, substituted or unsubstituted, preferably unsubstituted, hydrocarbyl, carbocyclyl or heterocyclyl. In further preferred metallocenes of formula (VIIa), each of R⁷, R⁸, R⁹ and R¹⁰ is independently selected from H, hydrocarbyl or carbocyclyl and preferably from H, hydrocarbyl or aryl. More preferably each R⁷, R⁸, R⁹ and R¹⁰ is independently selected from H, (1-6C)alkyl or phenyl. Still more preferably each of R⁷, R⁸, R⁹ and R¹⁰ is H or a (1-6C)alkyl.

In further preferred metallocenes of formula (VIIa) each of R⁷, R⁸, R⁹ and R¹⁰ is independently H, (1-6C)alkyl, more preferably H, or (1-4C)alkyl and still more preferably H or (1-2C)alkyl. In particularly preferred metallocenes of formula (IIa) each of R¹¹, R¹², R¹³ and R¹⁴ is methyl or H, and more preferably H.

In further preferred metallocenes of formula (VIIb), each R¹⁵ and R¹⁶ is independently selected from hydrogen, (1-4C)alkyl and phenyl, wherein the alkyl or phenyl group is optionally substituted with one or more groups selected from (1-4C)alkyl, (2-4C)alkenyl, (2-4C)alkynyl, (1-4C)alkoxy, halo, amino and nitro. Still more preferably each R¹⁵ and R¹⁶ is independently selected from hydrogen, methyl, n-butyl, tert-butyl and unsubstituted phenyl.

Preferred metallocenes of formulae (VIIa) and (VIIb) are those wherein:

each of R¹, R², R³, R⁴, R⁵ and R⁶ are independently selected from (1-2C)alkyl;
each of R⁷, R⁸, R⁹ and R¹⁰ are independently selected from hydrogen or (1-4C)alkyl;
each of R¹⁵ and R¹⁶ are independently selected from hydrogen, (1-4C)alkyl and phenyl, wherein the alkyl and phenyl group are optionally substituted with one or more groups selected from (1-4C)alkyl, (2-4C)alkenyl, (2-4C)alkynyl, (1-4C)alkoxy, halo, amino and nitro;
n and m are each independently 1 or 2;
Q is a bridging group selected from —[C(Rₐ)(R_{b})—C(R_{c})(R_{d})]— and —[Si(Rₑ)(R_{f})]—, wherein Rₐ, R_{b}, R_{c}, R_{d}, Rₑ and R_{f} are independently selected from hydrogen, hydroxyl, (1-6C)alkyl, (2-6C)alkenyl, (2-6C)alkynyl, (1-6C)alkoxy and aryl;
each Y is independently selected from halo or a (1-2C)alkyl group which is optionally substituted with halo, phenyl, or Si[(1-4C)alkyl]₃; and
X is zirconium or hafnium.

Further preferred metallocenes of formulae (VIIa) and (VIIb) are those wherein:

each of R¹, R², R³, R⁴, R⁵ and R⁶ are independently selected from (1-2C)alkyl;
each of R⁷, R⁸, R⁹ and R¹⁰ are independently selected from hydrogen or (1-4C)alkyl;
each of R¹⁵ and R¹⁶ are independently selected from hydrogen, (1-4C)alkyl and phenyl, wherein the alkyl and phenyl group are optionally substituted with one or more groups selected from (1-4C)alkyl, (2-4C)alkenyl, (2-4C)alkynyl, (1-4C)alkoxy, halo, amino and nitro;
n and m are each independently 1 or 2;
Q is a bridging group —[Si(Rₑ)(R_{f})]—, wherein Rₑ and R_{f} are independently selected from hydrogen, hydroxyl and (1-6C)alkyl;
each Y is independently selected from halo or (1-2C)alkyl, which is optionally substituted with one or more substituents selected from (1-4C)alkyl, halo, phenyl, or Si[(1-4C)alkyl]₃; and
X is zirconium or hafnium.

Further preferred metallocenes of formulae (VIIa) and (VIIb) are those wherein:

each of R¹, R², R³, R⁴, R⁵ and R⁶ are independently selected from methyl or ethyl, preferably methyl;
each of R⁷, R⁸, R⁹ and R¹⁰ are independently selected from hydrogen or (1-4C)alkyl;
each of R¹⁵ and R¹⁶ are independently selected from hydrogen, (1-4C)alkyl and phenyl, wherein the alkyl and phenyl group are optionally substituted with one or more groups selected from (1-4C)alkyl, (2-4C)alkenyl, (2-4C)alkynyl, (1-4C)alkoxy, halo, amino and nitro;
n and m are each independently 1 or 2;
Q is a bridging group —[Si(Rₑ)(R_{f})]—, wherein Rₑ and R_{f} are independently selected from hydrogen, hydroxyl and (1-6C)alkyl;
each Y is independently selected from halo and (1-2C)alkyl, which is optionally substituted with one or more substituents selected from (1-4C)alkyl, halo, phenyl, or Si[(1-4C)alkyl]₃; and
X is zirconium or hafnium.

Further preferred metallocenes of formulae (VIIa) and (VIIb) are those wherein:

each of R¹, R², R³, R⁴, R⁵ and R⁶ are independently selected from methyl or ethyl, preferably methyl;
each of R⁷, R⁸, R⁹ and R¹⁰ are selected from independently hydrogen or (1-4C)alkyl;
each of R¹⁵ and R¹⁶ are independently selected from hydrogen, (1-4C)alkyl and phenyl, wherein the alkyl and phenyl group are optionally substituted with one or more groups selected from (1-4C)alkyl, (2-4C)alkenyl, (2-4C)alkynyl, (1-4C)alkoxy, halo, amino and nitro;
n and m are each independently 1 or 2;
Q is a bridging group —[Si(Rₑ)(R_{f})]—, wherein Rₑ and R_{f} are independently selected from (1-6C)alkyl;
each Y is independently selected from halo, (1-2C)alkyl, which is optionally substituted with one or more substituents selected from (1-4C)alkyl, halo, phenyl, or Si[(1-4C)alkyl]₃; and
X is zirconium or hafnium.

Further preferred metallocenes are those of formulae (VIIIa) and (VIIIb):

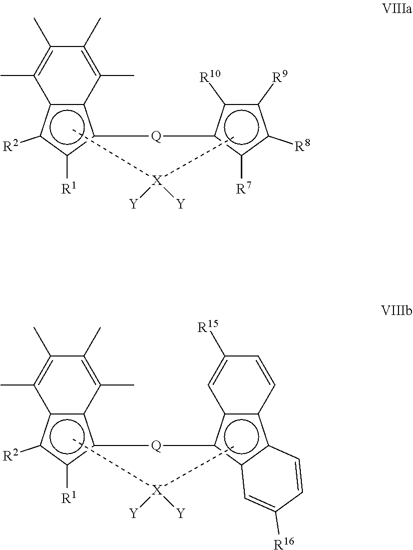

wherein
R¹, R², Q, X and Y are as defined in relation to formula (I);
R¹⁵ and R¹⁶ are independently selected from hydrogen, (1-4C)alkyl and phenyl, wherein the alkyl and phenyl are optionally substituted with one or more groups selected from (1-4C)alkyl, (2-4C)alkenyl, (2-4C)alkynyl, (1-4C)alkoxy, halo, amino and nitro. Preferably each R¹⁵ and R¹⁶ is independently selected from hydrogen, methyl, n-butyl, tert-butyl and unsubstituted phenyl.

In further preferred metallocenes of formulae (VIIIa) and (VIIIb) Q is a bridging group selected from —[C(Rₐ)(R_{b})—C(R_{c})(R_{d})]— and —[Si(Rₑ)(R_{f})]—, wherein Rₐ, R_{b}, R_{c}, R_{d}, Rₑ and R_{f} are independently selected from hydrogen, hydroxyl, (1-6C)alkyl, (2-6C)alkenyl, (2-6C)alkynyl, (1-6C)alkoxy and aryl. More preferably Q is a bridging group —[Si(Rₑ)(R_{f})]—, wherein Rₑ and R_{f} are independently selected from hydrogen, hydroxyl and (1-6C)alkyl. Still more preferably Q is a bridging group —[Si(Rₑ)(R_{f})]—, wherein Rₑ and R_{f} are independently selected from (1-6C)alkyl (e.g. methyl, ethyl, propyl or allyl).

In further preferred metallocenes of formulae (VIIIa) and (VIIIb) R¹ is methyl and R² is methyl or ethyl.

Still further preferred metallocenes of (VIIIa) and (VIIIb) are those wherein:

R¹ and R² are each independently (1-2C)alkyl;
R⁷, R⁸, R⁹ and R¹⁰ are each independently selected from hydrogen or (1-4C)alkyl;
R¹⁵ and R¹⁶ are each independently selected from hydrogen, (1-4C)alkyl and phenyl, wherein said alkyl and phenyl group are optionally substituted with one or more groups selected from (1-4C)alkyl, (2-4C)alkenyl, (2-4C)alkynyl, (1-4C)alkoxy, halo, amino and nitro;
Q is a bridging group selected from —[C(Rₐ)(R_{b})—C(R_{c})(R_{d})]— and —[Si(Rₑ)(R_{f})]—, wherein Rₐ, R_{b}, R_{c}, R_{d}, Rₑ and R_{f} are independently selected from hydrogen, hydroxyl, (1-6C)alkyl, (2-6C)alkenyl, (2-6C)alkynyl, (1-6C)alkoxy and aryl;
each Y is independently selected from halo or a (1-2C)alkyl group which is optionally substituted with halo, phenyl, or Si[(1-4C)alkyl]₃; and
X is zirconium or hafnium.

Still further preferred metallocenes of (VIIIa) and (VIIIb), are those wherein:

R¹ and R² are each independently selected from (1-2C)alkyl;
R⁷, R⁸, R⁹ and R¹⁰ are each independently selected from hydrogen or (1-4C)alkyl;
R¹⁵ and R¹⁶ are each independently selected from hydrogen, methyl, n-butyl, tert-butyl and unsubstituted phenyl;
Q is a bridging group selected from —[C(Rₐ)(R_{b})—C(R_{c})(R_{d})]— and —[Si(Rₑ)(R_{f})]—, wherein Rₐ, R_{b}, R_{c} and R_{d} are each hydrogen, and Rₑ and R_{f} are each independently (1-6C)alkyl, (2-6C)alkenyl or phenyl;
each Y is independently selected from halo or a (1-2C)alkyl group which is optionally substituted with halo, phenyl, or Si[(1-4C)alkyl]₃; and
X is zirconium or hafnium.

Still further preferred metallocenes of (VIIIa) and (VIIIb), are those wherein:

R¹ and R² are each independently selected from (1-2C)alkyl;
R⁷, R⁸, R⁹ and R¹⁰ are each independently selected from hydrogen or (1-4C)alkyl;
R¹⁵ and R¹⁶ are each independently selected from hydrogen, methyl, n-butyl, tert-butyl and unsubstituted phenyl;
Q is a bridging group —[Si(Rₑ)(R_{f})]—, wherein Rₑ and R_{f} are independently selected from hydrogen, hydroxyl and (1-6C)alkyl;
each Y is independently selected from halo, (1-2C)alkyl, which is optionally substituted with one or more substituents selected from (1-4C)alkyl, halo, phenyl, or Si[(1-4C)alkyl]₃; and
X is zirconium or hafnium.

Still further preferred metallocenes of (VIIIa) and (VIIIb), are those wherein:

R¹ and R² are each independently selected from ethyl or methyl, preferably methyl;
R⁷, R⁸, R⁹ and R¹⁰ are each independently selected from hydrogen or (1-4C)alkyl;
R¹⁵ and R¹⁶ are each independently selected from hydrogen, methyl, n-butyl, tert-butyl and unsubstituted phenyl;
Q is a bridging group —[Si(Rₑ)(R_{f})]—, wherein Rₑ and R_{f} are independently selected from hydrogen, hydroxyl and (1-6C)alkyl;
each Y is independently selected from halo, (1-2C)alkyl, or an aryloxy group which is optionally substituted with one or more substituents selected from (1-4C)alkyl, halo, phenyl, or Si[(1-4C)alkyl]₃; and
X is zirconium or hafnium.

Two particularly preferred metallocenes are shown below:

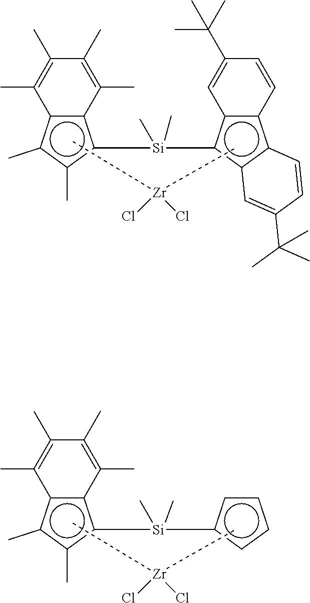

In further preferred metallocenes of formula (I), A is NR′. Such metallocenes are those of formula (IX):

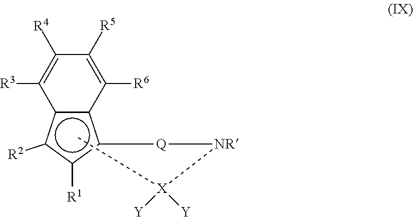

wherein R¹, R², R³, R⁴, R⁵, R⁶, Q, X and Y are as defined in relation to formula (I); and
R′ is (1-6alkyl).

In preferred metallocenes of formula (IX), R′ is (1-4alkyl). The alkyl groups may be linear or branched. Examples of suitable alkyl groups include methyl, ethyl, n-propyl, i-propyl, n-butyl and t-butyl. Particularly preferably R′ is t-butyl.

In preferred metallocenes of formula (IX), each of R¹, R², R³, R⁴, R⁵ and R⁶ is independently selected from hydrocarbyl or carbocyclyl and preferably from hydrocarbyl or aryl. More preferably each of R¹, R², R³, R⁴, R⁵ and R⁶ is independently selected from (1-6C)alkyl or phenyl. Still more preferably each of R¹, R², R³, R⁴, R⁵ and R⁶ is a (1-6C)alkyl.

In further preferred metallocenes of formula (IX), each of R¹, R², R³, R⁴, R⁵ and R⁶ is independently (1-6C)alkyl, more preferably (1-4C)alkyl and still more preferably (1-2C)alkyl. In particularly preferred metallocenes of formulae (IX), each of R¹ and R² is (1-4C)alkyl and each of R³, R⁴, R⁵ and R⁶ is methyl. In especially preferred metallocenes of formula (IX), R² is methyl or ethyl and each of R¹, R³, R⁴, R⁵ and R⁶ is methyl.

In particularly preferred metallocenes of formula (IX), X is preferably selected from Zr, Ti, Hf and more preferably Zr or Ti. In some preferred metallocenes of formula (IX) X is Ti.

In particularly preferred metallocenes of formula (IX), each Y group is the same. Preferably Y is selected from halo (e.g. Cl, Br, F), (1-6C)alkyl or phenyl and more preferably halo (e.g. Cl, Br, F) or (1-6C)alkyl. Optionally the (1-6C)alkyl or phenyl group is substituted with halo (e.g. Cl, Br, F), nitro, amino, phenyl, benzyl, (1-6C)alkoxy, aryloxy, or Si[(1-4C)alkyl]₃. In further preferred metallocenes of formula (IX), each Y is selected from chloro, bromo or methyl and more preferably chloro or bromo. Particularly preferably each Y is chloro.

In further preferred metallocenes of formula (IX) Q is a bridging group selected from —[C(Rₐ)(R_{b})—C(R_{c})(R_{d})]— and —[Si(Rₑ)(R_{f})]—, wherein Rₐ, R_{b}, R_{c}, R_{d}, Rₑ and R_{f} are independently selected from hydrogen, hydroxyl, (1-6C)alkyl, (2-6C)alkenyl, (2-6C)alkynyl, (1-6C)alkoxy and aryl. Preferably Rₐ, R_{b}, R_{c} and R_{d} are each hydrogen. Preferably Rₑ and R_{f} are each independently (1-6C)alkyl, (2-6C)alkenyl or phenyl. Still more preferably Rₑ and R_{f} are each independently (1-4C)alkyl, (2-4C)alkenyl or phenyl.

In other preferred metallocenes of formula (IX), Q is a bridging group having the formula —[C(RₐR_{b})]ₙ— wherein n is 2 or 3 and Rₐ and R_{b} are each independently hydrogen, (1-6C)alkyl or (1-6C)alkoxy. More preferably Q is —CH₂—CH₂— or —CH₂—CH₂—CH₂—, and yet more preferably —CH₂—CH₂—.

In still further preferred metallocenes of formula (IX), Q is a bridging group having the formula —[Si(Rₑ)(R_{f})]—, wherein Rₑ and R_{f} are each independently selected from methyl, ethyl, propyl, allyl or phenyl, more preferably methyl, ethyl, propyl and allyl and still more preferably Rₑ and R_{f} are each methyl.

Two particularly preferred metallocenes are shown below:

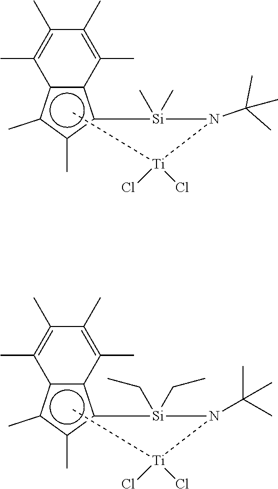

Another group of preferred metallocenes are those of formulae (XIa) and (XIb):

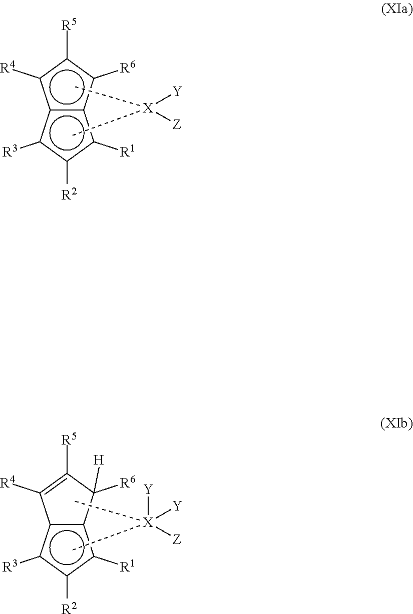

wherein R¹, R², R³, R⁴, R⁵ and R⁶ are each independently selected from substituted or unsubstituted, preferably unsubstituted, hydrocarbyl, carbocyclyl or heterocyclyl;
X is selected from Zr, Ti or Hf;
each Y is selected from halo, hydride, a phosphonate, sulfonate or borate anion, or a substituted or unsubstituted (1-6C)alkyl, (2-6C)alkenyl, (2-6C)alkynyl, (1-6C)alkoxy, aryl, aryl(1-4C)alkyl or aryloxy; and
Z is Y or Cp, wherein Cp is a cyclic group having a delocalised system of pi electrons.

In some preferred metallocenes of formulae (XIa) and (XIb), each of R¹, R², R³, R⁴, R⁵ and R⁶ is independently selected from hydrocarbyl or carbocyclyl and preferably from hydrocarbyl or aryl. More preferably each of R¹, R², R³, R⁴, R⁵ and R⁶ is independently selected from (1-6C)alkyl or phenyl. Still more preferably each of R¹, R², R³, R⁴, R⁵ and R⁶ is a (1-6C)alkyl.

In further preferred metallocenes of formulae (XIa) and (XIb) each of R¹, R², R³, R⁴, R⁵ and R⁶ is independently (1-6C)alkyl, more preferably (1-4C)alkyl and still more preferably (1-2C)alkyl. In particularly preferred metallocenes of formulae (XIa) and (XIb) each of R¹ and R² is independently (1-4C)alkyl and each of R³, R⁴, R⁵ and R⁶ is methyl. In especially preferred metallocenes of formulae (XIa) and (XIb) R² is methyl or ethyl and each of R¹, R³, R⁴, R⁵ and R⁶ is methyl. Still more preferably each of R¹ to R⁶ is methyl.

In some preferred metallocenes of formulae (XIa) and (XIb), X is selected from Zr, Ti, Hf and more preferably Zr or Ti. In particularly preferred metallocenes of formulae (XIa) and (XIb) X is Zr.

In preferred metallocenes of formulae (XIa) and (XIb), each Y group is the same. Preferably Y is selected from halo (e.g. Cl, Br, F), (1-6C)alkyl or phenyl and more preferably halo (e.g. Cl, Br, F) or (1-6C)alkyl. Optionally the (1-6C)alkyl or phenyl group is substituted with halo (e.g. Cl, Br, F), nitro, amino, phenyl, benzyl, (1-6C)alkoxy, aryloxy, or Si[(1-4C)alkyl]₃. In further preferred metallocenes of formulae (XIa) and (XIb), each Y is selected from chloro, bromo or methyl and more preferably chloro or bromo. Particularly preferably each Y is chloro.

In some preferred metallocenes of formulae (XIa) and (XIb), Z is Y. When Z is Y, preferred Y groups are the same as those set out above in relation to formula (XI). Thus most preferably Y is selected from chloro, bromo or methyl and still more preferably chloro.

In other preferred metallocenes of formulae (XIa) and (XIb), Z is Cp. Cp is preferably an unsubstituted or substituted ligand comprising at least one cyclopentadienyl group. More preferably Cp is unsubstituted or substituted cyclopentadienyl.

One preferred group of metallocenes of formula (XIa) are those of formula (XIc):

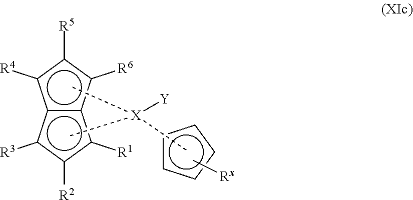

wherein
each of R¹, R², R³, R⁴, R⁵, R⁶, X and Y are as defined in relation to formula (XIa); and
R^{x} is selected from (1-6alkyl).

In preferred metallocenes of formula (XIc), R^{x} is selected from methyl, ethyl, n-propyl, i-propyl, n-butyl and t-butyl. Particularly preferably R^{x} is a linear alkyl and particularly a linear (1-2C alkyl). Especially preferably R^{x} is methyl.

In some preferred metallocenes of formula (XIc), each of R¹, R², R³, R⁴, R⁵ and R⁶ is independently selected from hydrocarbyl or carbocyclyl and preferably from hydrocarbyl or aryl. More preferably each of R¹, R², R³, R⁴, R⁵ and R⁶ is independently selected from (1-6C)alkyl or phenyl. Still more preferably each of R¹, R², R³, R⁴, R⁵ and R⁶ is a (1-6C)alkyl.

In further preferred metallocenes of formula (XIc) each of R¹, R², R³, R⁴, R⁵ and R⁶ is independently (1-6C)alkyl, more preferably (1-4C)alkyl and still more preferably (1-2C)alkyl. In particularly preferred metallocenes of formula (XIc) each of R¹, R², R³, R⁴, R⁵ and R⁶ is methyl.

In some preferred metallocenes of formula (XIc), X is selected from Zr, Ti, Hf and more preferably Zr or Ti. In particularly preferred metallocenes of formula (XIc) X is Zr.

In preferred metallocenes of formula (XIc), each Y group is the same. Preferably Y is selected from halo (e.g. Cl, Br, F), (1-6C)alkyl or phenyl and more preferably halo (e.g. Cl, Br, F) or (1-6C)alkyl. Optionally the (1-6C)alkyl or phenyl group is substituted with halo (e.g. Cl, Br, F), nitro, amino, phenyl, benzyl, (1-6C)alkoxy, aryloxy, or Si[(1-4C)alkyl]₃. In further preferred metallocenes of formula (XIc), each Y is selected from chloro, bromo or methyl and more preferably chloro or bromo. Particularly preferably each Y is chloro.

A further preferred group of metallocenes of formula (XIa) are those of formula (XId):

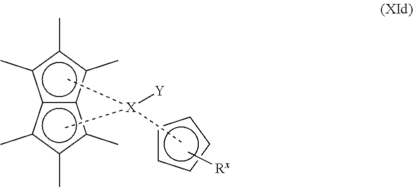

wherein
each of X and Y are as defined in relation to formula (XIa); and
R^{x} is selected from (1-6alkyl).

In preferred metallocenes of formula (XId), R^{x} is selected from methyl, ethyl, n-propyl, i-propyl, n-butyl and t-butyl. Particularly preferably R^{x} is a linear alkyl and particularly a linear (1-2 alkyl). Especially preferably R^{x} is methyl.

In some preferred metallocenes of formula (XId), X is selected from Zr, Ti, Hf and more preferably Zr or Ti. In particularly preferred metallocenes of formula (XId) X is Zr.

In preferred metallocenes of formula (XId), each Y group is the same. Preferably Y is selected from halo (e.g. Cl, Br, F), (1-6C)alkyl or phenyl and more preferably halo (e.g. Cl, Br, F) or (1-6C)alkyl. Optionally the (1-6C)alkyl or phenyl group is substituted with halo (e.g. Cl, Br, F), nitro, amino, phenyl, benzyl, (1-6C)alkoxy, aryloxy, or Si[(1-4C)alkyl]₃. In further preferred metallocenes of formula (XId), each Y is selected from chloro, bromo or methyl and more preferably chloro or bromo. Particularly preferably each Y is chloro.

Two particularly preferred metallocenes are shown below:

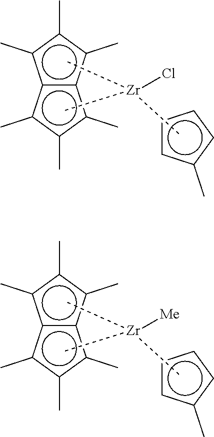

One preferred group of metallocenes of formula (XIb) are those of formula (XIe):

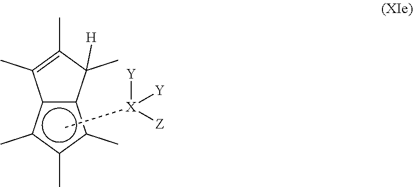

wherein
X, Y and Z are as defined in relation to formula (XIb).

In some preferred metallocenes of formula (XIe), X is selected from Zr, Ti, Hf and more preferably Zr or Ti. In particularly preferred metallocenes of formula (XIe) X is Zr.

In preferred metallocenes of formula (XIe), each Y group is the same. Preferably Y is selected from halo (e.g. Cl, Br, F), (1-6C)alkyl or phenyl and more preferably halo (e.g. Cl, Br, F) or (1-6C)alkyl. Optionally the (1-6C)alkyl or phenyl group is substituted with halo (e.g. Cl, Br, F), nitro, amino, phenyl, benzyl, (1-6C)alkoxy, aryloxy, or Si[(1-4C)alkyl]₃. In further preferred metallocenes of formula (IX), each Y is selected from chloro, bromo or methyl and more preferably chloro or bromo. Particularly preferably each Y is chloro.

In some preferred metallocenes Z is Y. Preferred Y group are as set out above in relation to formula (XIb). Particularly preferably Z is chloro.

In other preferred metallocenes Z is Cp wherein Cp is preferably an unsubstituted or substituted ligand comprising at least one cyclopentadienyl group. More preferably Cp is unsubstituted or substituted cyclopentadienyl. Such metallocenes are those of formula (XIf):

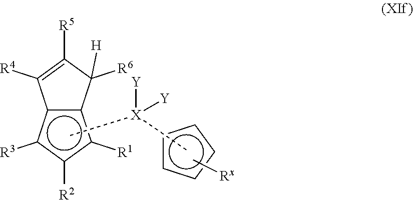

wherein each of R¹, R², R³, R⁴, R⁵, R⁶, X and Y are as defined in relation to formula (XIb); and
R^{x} is selected from (1-6alkyl).

In preferred metallocenes of formula (XIf), R^{x} is selected from methyl, ethyl, n-propyl, i-propyl, n-butyl and t-butyl. Particularly preferably R^{x} is a linear alkyl and particularly a linear (1-2C alkyl). Especially preferably R^{x} is methyl.

In some preferred metallocenes of formula (XIf), each of R¹, R², R³, R⁴, R⁵ and R⁶ is independently selected from hydrocarbyl or carbocyclyl and preferably from hydrocarbyl or aryl. More preferably each of R¹, R², R³, R⁴, R⁵ and R⁶ is independently selected from (1-6C)alkyl or phenyl. Still more preferably each of each of R¹, R², R³, R⁴, R⁵ and R⁶ is a (1-6C)alkyl.

In further preferred metallocenes of formula (XIf) each of R¹, R², R³, R⁴, R⁵ and R⁶ is independently (1-6C)alkyl, more preferably (1-4C)alkyl and still more preferably (1-2C)alkyl. In particularly preferred metallocenes of formula (XIf) each of R¹, R², R³, R⁴, R⁵ and R⁶ is methyl.

In some preferred metallocenes of formula (XIf), X is selected from Zr, Ti, Hf and more preferably Zr or Ti. In particularly preferred metallocenes of formula (XIf) X is Zr.

In preferred metallocenes of formula (XIf), each Y group is the same. Preferably Y is selected from halo (e.g. Cl, Br, F), (1-6C)alkyl or phenyl and more preferably halo (e.g. Cl, Br, F) or (1-6C)alkyl. Optionally the (1-6C)alkyl or phenyl group is substituted with halo (e.g. Cl, Br, F), nitro, amino, phenyl, benzyl, (1-6C)alkoxy, aryloxy, or Si[(1-4C)alkyl]₃. In further preferred metallocenes of formula (XIf), each Y is selected from chloro, bromo or methyl and more preferably chloro or bromo. Particularly preferably each Y is chloro.

Two particularly preferred metallocenes are shown below:

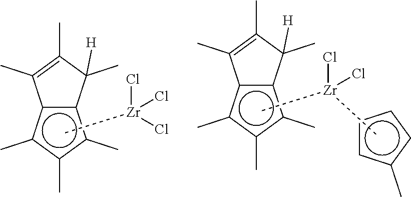

Some particularly preferred metallocenes for use in the process of the present invention are listed below:
EB(I*)₂ZrCl₂
Me₂SB(I*)₂ZrCl₂
Me₂SB(^{tBu2}Flu,I*)ZrCl₂
Me₂SB(Cp,I*)ZrCl₂
Me₂SB(^{tBu}N,I*)TiCl₂
Et₂SB(^{tBu}N,I*)TiCl₂
EBI*ZrCl₂
EBI*HfCl₂
EBI*TiCl₂
EBI*ZrMe₂
EBI*Zr(CH₂Ph)₂
EBI*Zr(CH₂tBu)₂
EBI*Zr(CH₂SiMe₃)₂
EBI*HfMe₂
EBI*Hf(CH₂Ph)₂
EBI*Hf(CH₂tBu)₂
EBI*Hf(CH₂SiMe₃)₂
Et₂SB(tBu₂Flu,I*)ZrCl₂
^{Me,Prop}SB(^{tBu2}Flu,I*)ZrCl₂
Me₂SB(^{tBu2}Flu,I*,^{3-ethyl})ZrCl₂
Me₂SB(Cp,I*)HfCl₂
Pn*ZrCp^{Me}Cl
Pn*ZrCp^{Me}Me
Pn*(H)ZrCl₃
Pn*(H)ZrCp^{Me}Cl₂
   wherein I* is C₉Me₇ (hexamethylindenyl), Cp is C₅H₅ (cyclopentadienyl), Flu is C₁₃H₁₀ (fluorenyl), Pn* is C₈Me₆ (permethylpentalenyl), Pn*(H) is C₈Me₆H (permethylhydropentalenyl), EB is ethylene bridge and R₂SB is SiR₂ bridge.

Especially preferred metallocenes for use in the process of the present invention are listed below
EB(I*)₂ZrCl₂
Me₂SB(I*)₂ZrCl₂
Me₂SB(^{tBu2}Flu,I*)ZrCl₂
Me₂SB(Cp,I*)ZrCl₂
Me₂SB(^{tBu}N,I*)TiCl₂
Et₂SB(^{tBu}N,I*)TiCl₂
Pn*ZrCp^{Me}Cl
Pn*ZrCp^{Me}Me
Pn*(H)ZrCl₃
Pn*(H)ZrCp^{Me}Cl₂
   wherein I* is C₉Me₇ (hexamethylindenyl), Cp is C₅H₅ (cyclopentadienyl), Flu is C₁₃H₁₀ (fluorenyl), Pn* is C₈Me₆ (permethylpentalenyl), Pn*(H) is C₈Me₆H (permethylhydropentalenyl), EB is ethylene bridge and R₂SB is SiR₂ bridge.

The preparation of the metallocenes can be carried out according or analogously to the methods known from the literature and is within the skills of a person skilled in the field. The ligands required to form the metallocenes of the invention can be synthesised by any process and the skilled organic chemist would be able to devise various synthetic protocols for the manufacture of the necessary ligands.

### Cocatalyst

In the process of the present invention a cocatalyst is preferably employed along with the metallocene catalyst. The cocatalyst may be, for example, aluminoxane, borane or borate. Preferably the cocatalyst is an aluminoxane cocatalyst. Preferably the aluminoxane is diluted in a C₄₋₁₀ saturated alkane or toluene. Preferably a mixture of the aluminoxane and metallocene is diluted in a C₄₋₁₀ saturated alkane or toluene and fed to the reactor.

The aluminoxane cocatalyst is preferably oligomeric. Preferably the aluminoxane cocatalyst is of formula (IV):

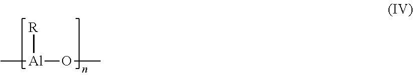

wherein
n is 1 to 20, more preferably 3 to 20 and still more preferably 6 to 20; and
R is C₁₋₁₀ alkyl (preferably C₁₋₅ alkyl), C₃₋₁₀ cycloalkyl, C₇₋₁₂ aralkyl, C₇₋₁₂ alkaryl, phenyl or naphthyl.

Aluminoxanes are formed on partial hydrolysis of organoaluminum compounds, for example those of the formula AlR₃, AlR₂Y and Al₂R₃Y₃ where R can be, for example, C₁₋₁₀ alkyl, preferably C₁₋₅ alkyl, C₃₋₁₀ cycloalkyl, C₇₋₁₂ aralkyl, C₇₋₁₂ alkaryl, phenyl or naphthyl, wherein Y is hydrogen, halogen (preferably chlorine or bromine), or C₁₋₁₀ alkoxy (preferably methoxy or ethoxy). The resulting oxygen-containing aluminoxanes are not in general pure compounds but mixtures of oligomers of the formula (IV).

Still more preferably the aluminoxane is a cage-like (e.g. multicyclic) molecule, e.g. with an approximate formula (Al_{1.4}R_{0.8}O)ₙ where n is 10-60 and R is an alkyl group, e.g. a C₁₋₂₀ alkyl group. In preferred aluminoxanes R is a C₁₋₈ alkyl group, e.g. methyl.

Methylaluminoxane (MAO) is a mixture of oligomers with a distribution of molecular weights, preferably with an average molecular weight of 700 to 1500. MAO is a preferred aluminoxane for use in the catalyst system. Since the aluminoxanes used in the process of the invention as cocatalysts are not, owing to their mode of preparation, pure compounds, the molarity of aluminoxane solutions hereinafter is based on their aluminium content. The ratio of Al in the aluminoxane to the metal ion of the metallocene is preferably in the range 20:1 to 1000:1 mol/mol, preferably 50:1 to 500:1, especially 100:1 to 200:1 mol/mol.

The aluminoxane may be modified with an aluminium alkyl or aluminium alkoxy compound. Especially preferred modifying compounds are aluminium alkyls, in particular, aluminium trialkyls such as trimethyl aluminium, triethyl aluminium and tri isobutyl aluminium. Trimethyl aluminium is particularly preferred. Preferred metallocenes and cocatalysts of the present invention are not modified with an organoaluminium compound.

Aluminoxanes, such as MAO, that are suitable for the preparation of the catalyst systems herein described are commercially available, e.g. from Albemarle and Chemtura. It is also possible to generate the activator in situ, e.g. by slow hydrolysis of trimethylaluminium inside the pores of a carrier. This process is well known in the art.

### General Multistage Polymerisation Process

The process of the present invention is a multistage polymerisation process. Preferably the process comprises two or three stages or steps and still more preferably two stages or steps. Preferably each stage or step of the multistage process is carried out in a different reactor. Preferably the process is semi-continuous or continuous.

In the process of the present invention, each polymerisation stage may be carried out in slurry, supercritical or gas phase conditions. In preferred processes of the invention, however, at least the first polymerisation stage is carried out in slurry conditions. In further preferred processes of the invention, the second polymerisation stage is carried out in slurry, supercritical or gas phase conditions and more preferably in slurry conditions. In yet further preferred processes of the invention, the third polymerisation stage (when present) is carried out in slurry, supercritical or gas phase conditions and more preferably in slurry conditions.

Suitable polymerisation processes include, for example, Hostalen staged (where catalyst system and polymer sequentially pass from reactor to reactor) tank slurry reactor process for polyethylene by LyondellBasell, Lyondell Basell-Maruzen staged tank slurry reactor process for polyethylene, Mitsui staged tank slurry reactor process for polyethylene by Mitsui, CPC loop slurry polyethylene process by Chevron Phillips, Innovene staged loop slurry process by Ineos, Borstar staged slurry loop and gas phase reactor process for polyethylene by Borealis and Spheripol polypropylene staged slurry (bulk) loop and gas phase process by LyondellBasell.

The conditions for carrying out slurry polymerisations are well established in the art. The polymerisation is preferably carried out in conventional circulating loop or stirred tank reactors, preferably in stirred tank reactors.

The reaction temperature is preferably in the range 30 to 120° C., e.g. 50 to 100° C. The reaction pressure will preferably be in the range 1 to 100 bar, e.g. 5 to 70 bar or 2 to 50 bar. The total residence time in the reactors is preferably in the range 0.2 to 6 hours, e.g. 0.5 to 1.5 hours.

The diluent used for slurry polymerisations will generally be an aliphatic hydrocarbon having a boiling point in the range −70 to 100° C. The diluent is preferably a hydrocarbon of 3-10 carbon atoms. Preferably, it is n-hexane or isobutane. Most preferably, it is n-hexane.

The conditions for carrying out gas phase polymerisation are well established in the art. The polymerisation is preferably carried out in a conventional gas phase reactor such as a bed fluidised by gas feed or in a mechanically agitated bed, or in a circulating bed process.

The gas phase reaction temperature is preferably in the range 30 to 120° C., e.g. 50 to 100° C. The total gauge pressure is preferably in the range 1 to 100 bar, e.g. 10 to 40 bar. The total monomer partial pressure is preferably in the range 2 to 20 bar, e.g. 3 to 10 bar. The residence time in each gas phase reactor is preferably in the range 0.3 to 7 hours, more preferably 0.5 to 4 hours, still more preferably 0.7 to 3 hours, e.g. 0.9 to 2 hours.

Hydrogen is also preferably fed into the gas phase reactor to function as a molecular weight regulator. Preferably nitrogen is also fed into the gas phase reactor. It functions as a flushing gas.

Preferably a C₃₋₈ saturated hydrocarbon is also fed into the gas phase reactor. Particularly preferably a C₃₋₆ alkane (e.g. propane, n-butane) is fed into the reactor. It functions to increase heat transfer efficiency, thereby removing heat more efficiently from within the reactor.

Regardless of the polymerisation conditions, when present, the α-olefin comonomer is preferably an alpha olefin of 3-10 carbon atoms. Preferably, it is propylene, 1-butene, 1-pentene, 4-methyl-pentene-1, n-hexene or n-octene. In a slurry polymerisation if the diluent is n-hexane, then preferably the comonomer is propylene, 1-butene, 1-pentene or 4-methyl-pentene-1. More preferably, the comonomer is 1-butene or 1-pentene and most preferably it is 1-butene.

Hydrogen is preferably fed into at least one, and preferably all, of the reactors to function as a molecular weight regulator. Preferably the first polymerisation stage is carried out in the presence of hydrogen and particularly preferably in the presence of a high level of hydrogen. The ratio of hydrogen and ethylene in the first reactor is preferably 0.1-10 mol/kmol and more preferably 0.2 to 4 mol/kmol. The second polymerisation stage may be carried out in the absence or presence of hydrogen. Any additional (e.g. third), polymerisation stage may be carried out in the absence or presence of hydrogen. When used in the second or additional (e.g. third) polymerisation stages, hydrogen is preferably present in a lower level than in the first polymerisation stage. When used in the second or additional (e.g. third) polymerisation stage, the ratio of hydrogen and ethylene is preferably 0 to 0.1:1 mol/kmol and more preferably 0 to 0.2:1 mol/kmol.

In a preferred process of the invention, a solution of metallocene and optionally cocatalyst (e.g. aluminoxane) in a solvent is initially prepared. Preferably a separate solution of cocatalyst (e.g. aluminoxane) in a solvent is prepared. Preferably the solvent for both solutions is an aromatic hydrocarbon. Preferably the solvent is selected from toluene, benzene, ethylbenzene, propylbenzene, butylbenzene and xylene. Toluene is a preferred solvent. The solutions may each comprise one or more solvents. Preferably the same solvent is employed for both solutions.

In a preferred process of the invention, a first reactor is initially charged with diluent and hydrogen. The above described solutions (i.e. metallocene and optionally cocatalyst and cocatalyst respectively), ethylene and optionally α-olefin comonomer are then fed into the reactor. Preferably the polymer precipitates out of solution as it forms.

Preferably the polymerisation reactions are carried out as a continuous or semi-continuous process. Thus monomers, diluent and hydrogen are preferably fed continuously or semi-continuously into the reactor. Additionally the slurry from any previous reactor may be fed continuously or semi-continuously. Preferably the catalyst system, when a direct feed is required, is also fed continuously or semi-continuously into the reactor. Still more preferably polymer slurry is continuously or semi-continuously removed from the reactor. By semi-continuously is meant that addition and/or removal is controlled so they occur at relatively short time intervals compared to the polymer residence time in the reactor, e.g. between 20 seconds to 2 minutes, for at least 75% (e.g. 100%) of the duration of the polymerisation.

Preferably the concentration of polymer present in the reactor during polymerisation is in the range 15 to 55% wt based on total, e.g. slurry, more preferably 25 to 50% wt based on total, e.g. slurry. Such a concentration can be maintained by controlling the rate of addition of monomer, the rate of addition of diluent and catalyst system and, to some extent, the rate of removal of polymer e.g. polymer slurry from the, e.g. slurry reactor.

The catalyst employed in the process of the invention is unsupported and has a high activity. Preferably the catalyst activity is greater than 20,000 kg PE/(mol metal*h), more preferably greater than 40,000 kg PE/(mol metal*h) and still more preferably greater than 60,000 kg PE/(mol metal*h). Without wishing to be bound by theory, this is thought to be due to the greater access of the active site of the catalyst to the ethylene and comonomers which results in a higher concentration of monomers in the active site of the catalyst. Economically these advantages are significant versus the use of supported catalysts.

The unsupported catalyst employed in the process of the invention also has a high productivity. Preferably the catalyst productivity is greater than 19,000 kg PE/(mol metal), more preferably greater than 30,000 kg PE/(mol metal) and still more preferably greater than 50,000 kg PE/(mol metal).

Preferably no reactor fouling occurs in the process of the invention. One shortcoming of many polymerisation processes is the tendency of the reactor to become fouled. The fouling, as used herein, denotes the phenomenon that particles of the polymerisation product or particles of the solid catalyst in the slurry or gas phase deposit on the walls of a reactor. The accumulation of particles on the reactor walls results in various problems including reduced heat transfer. Generally in the slurry polymerisation, a tank or loop reactor equipped with a stirrer is used. When fouling occurs, the smoothness of the wall surface of the reactor is lost and the power used for stirring is drastically increased; at the same time, the heat transfer through the reactor wall is reduced. The result is a failure of temperature control, and in the worst case, the reaction can run out of control. Once fouling has proceeded, it is very difficult to remove the deposit during continuous operation, and in many cases, the reactor does not regain its normal state unless cleaned after disassembling.

Preferably there is no reactor fouling in the first polymerisation stage. Preferably this manifests in the production of a first ethylene polymer having a bulk density of 100 to 200 g/dm³. Preferably the ethylene polymer from the first polymerisation stage is in the form of free flowing particles. Preferably there is no reactor fouling in the second or later polymerisation stages. This manifests in the production of a multimodal polyethylene having a bulk density of at least 250 g/dm³, e.g. 250-400 g/cm³. This is highly beneficial as the multimodal polyethylene particles with good morphology are facile to handle and to process by extrusion in the manufacture of pipes. It is, however, also highly surprising because reactor fouling is commonplace with the use of unsupported metallocene catalysts, generally due to inferior polymer morphology. Without wishing to be bound by theory the absence of reactor fouling is thought to be due to preferable production of homopolymer and controlled use of hydrogen in the first polymerisation stage. The production of homopolymer with higher melting point compared to ethylene copolymer and production of low molecular weight polyethylene in controlled molecular weight range in the first stage reactor are believed to be the key factors to be able to avoid fouling also in the later stages.

Preferably the first polymerisation stage produces a lower molecular weight ethylene (LMVV) polymer. Preferably the first polymerisation stage produces a homopolymer. Preferably the second polymerisation stage produces a higher molecular weight ethylene (HMW) polymer. Preferably the second polymerisation stage produces a copolymer.

### First Preferred Process

A preferred process of the invention consists of a first polymerisation stage and a second polymerisation stage. In such a process the first polymerisation stage preferably produces 1 to 65% wt, more preferably 10 to 60% wt and still more preferably 30 to 55% wt of the multimodal polyethylene. In such a process the second polymerisation stage preferably produces 35 to 99% wt, more preferably 40 to 85% wt and still more preferably 45 to 70% wt of the multimodal polyethylene.

In a preferred process the first reactor is preferably fed with catalyst, ethylene, optionally α-olefin and hydrogen. Diluent is also fed. Preferably essentially the catalyst for all of the reactors is fed to the first reactor.

The conditions used for polymerisation, and especially hydrogen and comonomer levels in the reactor, depend on the metallocene catalyst type used. The skilled man will be able to make any necessary modifications. Preferably, however, the conditions for carrying out the polymerisation in the first reactor are generally as follows:
Temperature: 50 to 270° C., more preferably 60 to 120° C., still more preferably 50 to 100° C., yet more preferably 70 to 90° C.
Pressure: 1 to 220 bar, preferably 1 to 60 bar, more preferably 1 to 35 bar, still more preferably 5 to 15 bar (if hexane is used) and 15 to 35 bar (if isobutane is used)
Partial pressure of ethylene: 1-200 bar, preferably 1-15 bar, more preferably 1-10 bar, still more preferably 2-10 bar
Residence time: 1 minute to 6 hours, preferably 10 minutes to 4 hours, more preferably 15 minutes-1 hour
Diluent/solvent: C₄₋₁₀ saturated alkane, preferably hexane or isobutane as diluent
Hydrogen in reactor (H₂:ethylene, mol/kmol): 0.1:1 to 10:1, preferably 0.2:1 to 4:1 Comonomer in reactor (comonomer:ethylene, mol/kmol): 0 to 50:1, preferably 0 to 10:1, more preferably 0.

Preferably the optional comonomer is 1-butene or 1-hexene.

The flow out of first reactor is directed to the second reactor. The most volatile components are preferably removed from the outgoing flow of the first reactor such that more than 80% of the hydrogen, more preferably at least 90% of the hydrogen and more preferably substantially all of the hydrogen, is removed before the flow enters the second reactor.

The second reactor is fed with ethylene and optionally α-olefin comonomer. Hydrogen is preferably present at a lower level than in the first reactor or absent. Preferably the conditions for carrying out the polymerisation in the second reactor are as follows:
Temperature: 50 to 290° C., preferably 50 to 100° C., more preferably 60 to 100° C., still more preferably 70 to 90° C.
Pressure: 1 to 200 bar, preferably 1 to 60 bar, more preferably 1 to 15 bar, still more preferably 2 to 15 bar, yet more preferably 2 to 10 bar, e.g. 5 to 15 bar (if hexane is used) and 15 to 35 bar (if isobutane is used)
Partial pressure of ethylene: 0.2-200 bar, preferably 0.5 to 15 bar, more preferably 0.5-10 bar, e.g. 0.7 to 8 bar
Residence time: 1 minute to 4 hours, preferably 10 minutes to 4 hours, more preferably 15 minutes to 2 hours, yet more preferably 15 minutes-1 hour
Diluent/solvent: C₄₋₁₀ saturated alkane, preferably hexane or isobutane as diluents.
Hydrogen in reactor (H₂:ethylene, mol/kmol): 0 to 1:1, preferably 0 to 0.2:1
Comonomer in reactor (comonomer:ethylene, mol/kmol): 0.1:1 to 200:1, preferably 2:1 to 50:1

Preferably the optional comonomer is 1-butene or 1-hexene. Preferably H₂ is absent.

### Second Preferred Process

A further preferred process of the invention consists of a first polymerisation stage, a second polymerisation stage and a third polymerisation stage. Preferably the third polymerisation is carried out in slurry conditions. Preferably the first polymerisation produces a homopolymer. Preferably the second and/or third polymerisation produces a copolymer. Preferably the second and third polymerisation is carried out in the presence of a lower amount of hydrogen than the first polymerisation stage or in absence of hydrogen. Preferably there is no reactor fouling in the second and/or third polymerisation stage.

One preferred three stage polymerisation comprises sequential steps (a)-(c):

(a) polymerising ethylene and optionally an α-olefin comonomer in a first polymerisation stage to produce a lower molecular weight ethylene (LMVV) polymer;
(b) polymerising ethylene and optionally an α-olefin comonomer in a second polymerisation stage to produce a first higher molecular weight ethylene polymer (HMW1); and
(c) polymerising ethylene and optionally an α-olefin comonomer in a third polymerisation stage to produce a second higher molecular weight ethylene copolymer (HMW2).

In a preferred process of the invention, the multimodal polyethylene is prepared by preparing its ethylene polymer components in sequence from lowest molecular weight to highest molecular weight, i.e. the molecular weight of the components increases in the order LMW<HMW1<HMW2. In a further preferred process of the invention, the multimodal polyethylene is prepared by preparing its ethylene polymer components in sequence from lowest comonomer content to highest comonomer content, i.e. the comonomer content of the components increases in the order LMW<HMW1<HMW2. In this latter case the LMW polymer will generally also be the lowest molecular weight polymer, but either of HMW1 or HMW2 may be the highest molecular weight polymer. Preferably HMW2 has the highest comonomer content and the highest molecular weight.

In a preferred process, during the polymerisation to produce a first higher molecular weight ethylene polymer, at least some of the lower molecular weight ethylene polymer is present in the second reactor. In a further preferred process only a portion of the lower molecular weight ethylene polymer is present in the second reactor. Preferably the other portion of the lower molecular weight ethylene polymer is transferred directly to the polymerisation of the second higher molecular weight ethylene polymer in the third reactor. In a particularly preferred process, during the polymerisation to produce a second higher molecular weight ethylene polymer, the lower molecular weight ethylene polymer and the first higher molecular weight ethylene polymer, are present in the third reactor.

In this preferred process essentially all of the catalyst used in the reactors is preferably fed to first (LMVV) reactor. The first reactor is also preferably fed with ethylene, optionally α-olefin and hydrogen. Diluent is also fed. Preferably the conditions for carrying out the polymerisation in the first reactor are as follows:
Temperature: 50 to 270° C., more preferably 60 to 120° C., still more preferably 50 to 100° C., yet more preferably 70 to 90° C.
Pressure: 1 to 220 bar, preferably 1 to 60 bar, more preferably 1 to 35 bar, still more preferably 5 to 15 bar (if hexane is used) and 15 to 35 bar (if isobutane is used)
Partial pressure of ethylene: 1-200 bar, preferably 1-15 bar, more preferably 1-10 bar, still more preferably 2-10 bar
Residence time: 1 minute to 6 hours, preferably 10 minutes to 4 hours, more preferably 15 minutes-1 hour
Diluent/solvent: C₄₋₁₀ saturated alkane, preferably hexane or isobutane as diluent
Hydrogen in reactor (H₂:ethylene, mol/kmol): 0.1:1 to 10:1, preferably 0.2:1 to 4:1.
Comonomer in reactor (comonomer:ethylene, mol/kmol): 0 to 50:1, preferably 0 to 10:1, more preferably 0.

Preferably the optional comonomer is 1-butene or 1-hexene.

The polymerisation in the first reactor preferably produces 30-70% wt of the total multimodal polyethylene, more preferably 35-65% wt, still more preferably 40-60% wt and most preferably 45-55% wt.

The flow out of first (LMW) reactor is preferably directed to the second reactor. Preferably 100% of flow goes to the second reactor. The most volatile components are preferably removed from the outgoing flow of the first reactor such that more than 80% of the hydrogen, more preferably at least 90% of the hydrogen and still more preferably 100% of the hydrogen, is removed before the flow enters the second reactor.

The second reactor is fed with ethylene and optionally α-olefin comonomer. Hydrogen is optionally fed into the second reactor. Diluent is also preferably fed into the second reactor. Preferably the conditions for carrying out the polymerisation in the second reactor are as follows:
Temperature: 50 to 290° C., preferably 50 to 100° C., more preferably 60 to 100° C., still more preferably 70 to 90° C.
Pressure: 1 to 200 bar, preferably 1 to 60 bar, more preferably 1 to 15 bar, still more preferably 2 to 15 bar, yet more preferably 2 to 10 bar, e.g. 5 to 15 bar (if hexane is used) and 15 to 35 bar (if isobutane is used)
Partial pressure of ethylene: 0.2-200 bar, preferably 0.5 to 15 bar, more preferably 0.5-10 bar, e.g. 0.7 to 8 bar
Residence time: 1 minute to 4 hours, preferably 10 minutes to 4 hours, more preferably 15 minutes to 2 hours, yet more preferably 15 minutes-1 hour
Diluent/solvent: C₄₋₁₀ saturated alkane, preferably hexane or isobutane as diluent.
Hydrogen in reactor (H₂:ethylene, mol/kmol): 0 to 1:1, preferably 0 to 0.2:1
Comonomer in reactor (comonomer:ethylene, mol/kmol): 0.1:1 to 200:1, preferably 1:1 to 20:1

Preferably the optional comonomer is 1-butene or 1-hexene.

In the second reactor, 30-70% wt of the total multimodal polyethylene is preferably made, more preferably 35-65% wt, still more preferably 40-60% wt and most preferably 40-50% wt.

Essentially all of the flow out of second reactor is preferably fed into the third reactor. Any hydrogen is preferably removed. To the third reactor is fed ethylene and optionally α-olefin comonomer. Hydrogen is also optionally fed to the third reactor. Diluent is additionally preferably fed to the third reactor. Preferably the conditions for carrying out the polymerisation in the third reactor are as follows:
Temperature: 50 to 320° C., more preferably 50 to 100° C., still more preferably 60 to 100° C., yet more preferably 70 to 90° C.
Pressure: 0.5 to 220 bar, more preferably 1 to 60 bar, still more preferably 1 to 10 bar, preferably 1.5 to 7 bar, still more preferably 5 to 15 bar (if hexane is used) and 15 to 35 bar (if isobutane is used)
Partial pressure of ethylene: 0.2 to 200 bar, more preferably 0.25 to 10 bar, still more preferably 0.3-4 bar
Residence time: 0.2 minutes to 2 hours, preferably 2 minutes to 1 hour, more preferably 5 to 30 minutes
Diluent/solvent: C₄₋₁₀ saturated alkane, preferably hexane or isobutane as diluent
Hydrogen in reactor (H₂:ethylene, mol/kmol): 0 to 1:1, preferably 0 to 0.2:1
Comonomer in reactor (comonomer:ethylene, mol/kmol): 0.1:1 to 200:1, preferably 10:1 to 50:1

Preferably the optional comonomer is 1-butene or 1-hexene.

The molar ratio between α-olefin comonomer and ethylene in the third reactor is preferably 1.5-20 times, more preferably 2-15 times, and still more preferably 3-10 times higher, than the molar ratio between comonomer and ethylene in the second reactor.

In the third reactor, 0.5-30% wt of the total multimodal polyethylene is preferably made. Preferably at least 1.0% wt, e.g. 1.2% wt or 1.5% wt of the total multimodal polyethylene is made in the third reactor. Preferably less than 30% wt, e.g. 27% wt or 25% wt of the total multimodal polyethylene is made in the third reactor. Particularly preferably 1 to 25% wt, more preferably 1.5-15% wt and most preferably 1.5-9% wt of the total multimodal polyethylene is made.

Following polymerisation in the third reactor the multimodal polyethylene is preferably obtained by centrifugation or flashing.

Optionally, the polymerisation of the second and third reactor may be performed as polymerisation in different zones with different polymerisation conditions within a single reactor shell. However, this is not preferred.

### Third Preferred Process

In a further preferred process of the invention the multimodal polyethylene is prepared by preparing its ethylene polymer components in the sequence lower molecular weight ethylene polymer, second higher molecular weight ethylene copolymer and then first higher molecular weight ethylene copolymer.

This preferred process comprises the sequential steps (a)-(c):

(a) polymerising ethylene and optionally an α-olefin comonomer in a first reactor to produce a lower molecular weight ethylene polymer (LMW);
(b) polymerising ethylene and optionally an α-olefin comonomer in a second reactor to produce a second higher molecular weight ethylene copolymer (HMW2); and
(c) polymerising ethylene and optionally an α-olefin comonomer in a third reactor to produce a first higher molecular weight ethylene copolymer (HMW1).

In this preferred process of the invention, the multimodal polyethylene is preferably prepared by preparing its ethylene polymer components in sequence lowest molecular weight, highest molecular weight and then second highest molecular weight (LMW/HMW2/HMW1), i.e. the molecular weight of the components increases in the order LMW<HMW1<HMW2. In a further preferred process of the invention, the multimodal polyethylene is prepared by preparing its ethylene polymer components in sequence lowest comonomer content, highest comonomer content and then second highest comonomer content, i.e. the comonomer content of the components increases in the order LMW<HMW1<HMW2. In this latter case the LMW polymer will generally also be the lowest molecular weight polymer, but either of HMW1 or HMW2 may be the highest molecular weight polymer. Preferably HMW2 has the highest comonomer content and the highest molecular weight.

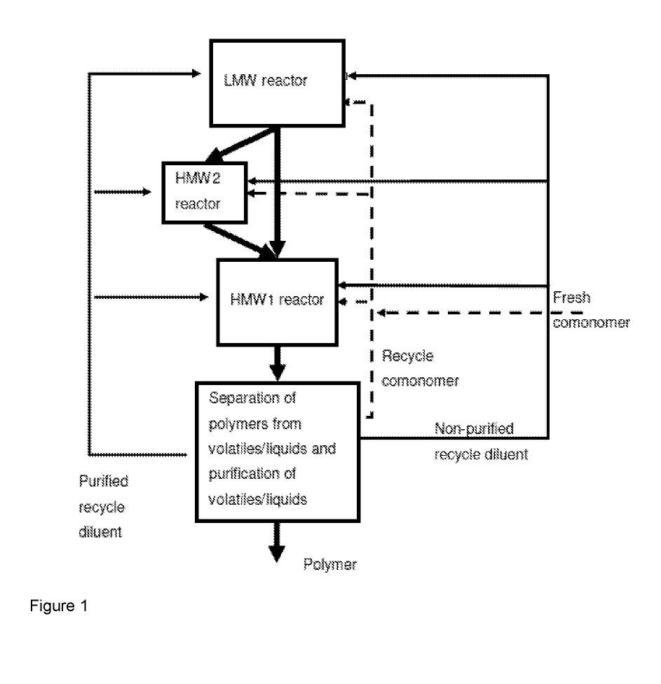

This preferred process is shown in FIG. 1 which is discussed in more detail below.

In a preferred process, during the polymerisation to produce a second higher molecular weight ethylene polymer, at least some of the lower molecular weight ethylene polymer is present in the second reactor. In a further preferred process only a portion of the lower molecular weight ethylene polymer is present in the second reactor. Preferably the other portion of the lower molecular weight ethylene polymer is transferred directly to the polymerisation of the first higher molecular weight ethylene polymer in the third reactor. In a further preferred process, during the polymerisation to produce a first higher molecular weight ethylene polymer, the lower molecular weight ethylene polymer and the second higher molecular weight ethylene polymer, are present in the third reactor.

In this preferred process essentially all of the catalyst used in the reactors is preferably fed to the first reactor. To the first reactor is also preferably fed ethylene, hydrogen and optionally α-olefin comonomer. Diluent is also preferably fed to the first reactor. Preferably the conditions for carrying out the polymerisation in the first reactor are as follows:
Temperature: 50 to 270° C., more preferably 50 to 120° C., more preferably 50 to 100° C., still more preferably 70 to 90° C.
Pressure: 1 to 220 bar, preferably 1 to 70 bar, more preferably 3 to 20 bar, still more preferably 5 to 15 bar (if hexane is used) and 15 to 35 bar (if isobutane is used)
Partial pressure of ethylene: 0.2 to 200 bar, more preferably 0.5 to 15 bar, still more preferably 1-10 bar, e.g. 2-10 bar
Residence time: 1 minute to 6 hours, preferably 10 minutes to 4 hours, more preferably 15 minutes-2 hours
Diluent/solvent: C₄₋₁₀ saturated alkane, preferably hexane or isobutane as diluent

Hydrogen in reactor (H₂:ethylene, mol/kmol): 0.1:1 to 10:1, preferably 0.2:1 to 4:1.

Comonomer in reactor (comonomer:ethylene, mol/kmol): 0 to 50:1, preferably 0 to 10:1, more preferably 0.

Preferably the optional comonomer is 1-butene, 1-pentene, 1-hexene or 1-octene and more preferably 1-butene or 1-hexene.

The polymerisation in the first reactor preferably produces 30-70% wt of the total multimodal polyethylene, more preferably 35-65% wt, still more preferably 40-60% wt and most preferably 45-55% wt.

Hydrogen is preferably removed from the flow out of the first reactor. The flow out of first reactor, e.g. after removing hydrogen, may all be transferred to the second reactor. More preferably however it is split between going directly to the third reactor and going via the second reactor. Preferably 5-100% of flow goes via the second reactor, more preferably 10-70%, most preferably 15-50%, for example 20-40%. Optionally unwanted compounds are removed from the flow. The most volatile components are preferably removed from the outgoing flow of the first reactor, e.g. such that more than 96% of the hydrogen is removed before the flow enters the second reactor and more than 80% of the hydrogen is removed before flow enters third reactor directly. The flow entering the second reactor and the flow entering the third reactor directly therefore comprises mainly polyethylene and diluent. Preferably substantially all (e.g. all) of the hydrogen is removed before the flow is split. The optional split may be achieved using control via mass flow measurements of, e.g. the slurry, and/or using volumetric feeders or switch flow between the second and third reactors in short sequences.

To the second reactor is fed ethylene and optionally α-olefin comonomer. Hydrogen is also optionally fed to the second reactor. A significant fraction of the comonomer feed is preferably nonpurified recycle stream from the third reactor. Diluent is preferably fed to the second reactor. Preferably the conditions for carrying out polymerisation in the second reactor are as follows:
Temperature: 50 to 290° C., preferably 55 to 120° C., more preferably 50 to 100° C., e.g. 60 to 100° C., yet more preferably 70 to 90° C.
Pressure: 0.5 to 220 bar, preferably 0.75 to 70 bar, more preferably 1 to 50 bar, still more preferably 1 to 16 bar, e.g. 5 to 15 bar (if hexane is used) and 15 to 35 bar (if isobutane is used)
Partial pressure of ethylene: 0.2 to 200 bar, preferably 0.3 to 10 bar, more preferably 0.3-4 bar
Residence time: 0.2 minutes to 1 hour, preferably 1 minute to 1 hour, preferably 2 to 20 minutes
Diluent: Either absent (for gas phase) or C₄₋₁₀ saturated alkane, more preferably hexane or isobutane as diluents, and still more preferably hexane as diluent
Hydrogen in reactor (H₂:ethylene, mol/kmol): 0 to 1:1, preferably 0 to 0.2:1
   Comonomer in reactor (comonomer:ethylene, mol/kmol): 0.1:1 to 200:1, preferably 10:1 to 50:1

Preferably the optional comonomer is 1-butene, 1-pentene, 1-hexene or 1-octene and most preferably 1-butene or 1-hexene.

In the second reactor, 0.5-30% wt of the total multimodal polymer is preferably made. Preferably at least 1.0% wt, e.g. 1.2% wt or 1.5% wt of the total multimodal polyethylene is made in the second reactor. Preferably less than 30% wt, e.g. 27% wt or 25% wt of the total multimodal polyethylene is made in the second reactor. Particularly preferably 1 to 25% wt, more preferably 1.5-15% wt and most preferably 1.5-9% wt of the total multimodal polyethylene is made.

Essentially all of the polymer flow out of second reactor is preferably fed into the third reactor. This flow comprises mainly polyethylene and diluent. Optionally volatiles are partially removed from the flow before it enters the third reactor, e.g. volatile comonomer (e.g. 1-butene) may be removed from the flow. Any polymer flow out of the first reactor that does not enter the second reactor is also preferably fed into the third reactor.

To the third reactor is fed ethylene and optionally α-olefin comonomer. Optionally hydrogen is fed to the third reactor. Diluent or solvent is optionally fed to the third reactor. Preferably the major amount of the comonomer feed comes with the polymer from the second reactor. Preferably the conditions for carrying out the polymerisation in the third reactor are as follows:
Temperature: 50 to 320° C., preferably 50 to 120° C., more preferably 50 to 100° C. and still more preferably 70 to 90° C.
Pressure: 1 to 220 bar, preferably 1 to 70 bar, more preferably 1 to 50 bar, still more preferably 1 to 15 bar, and still more preferably 2 to 10 bar, e.g. 5 to 15 bar (if hexane is used) and 15 to 35 bar (if isobutane is used)
Partial pressure of ethylene: 0.4-200 bar, more preferably 0.5 to 15 bar, still more preferably 0.5-6 bar
Residence time: 1 minute to 4 hours, preferably 0.5 to 4 hours, more preferably 1-2 hours
Diluent: Either absent (for gas phase) or C₄₋₁₀ saturated alkane, more preferably hexane or isobutane as diluents, still more preferably hexane as diluent
Hydrogen in reactor (H₂:ethylene, mol/kmol): 0 to 1:1, preferably 0 to 0.2:1
Comonomer in reactor (comonomer:ethylene, mol/kmol): 0.1:1 to 200:1, preferably 1:1 to 20:1

Preferably the optional comonomer is 1-butene, 1-pentene, 1-hexene or 1-octene and still more preferably 1-butene or 1-hexene

The molar ratio comonomer/ethylene is preferably 5-90% of that in the second reactor, more preferably 10-40% of that in the second reactor.

In the third reactor, 30-70% wt of the total multimodal polymer is preferably made, more preferably 35-65% wt, still more preferably 40-60% wt and most preferably 40-50% wt.

Optionally a portion or part of the flow leaving the third reactor is recycled to the second reactor.

Following polymerisation in the third reactor the polyethylene is preferably obtained by centrifugation or flashing.

### Multimodal Polyethylene

The final multimodal polyethylene for processing into articles such as pipes and films (e.g. blown film) will often contain additives such as carbon black and colourants as described below which are typically compounded into the polyethylene as a concentrated masterbatch after polyethylene synthesis is completed. The following details in relation to the polyethylene refer to the polyethylene per se and do not include any further additives unless explicitly stated.

The multimodal polyethylene preferably has a bimodal or trimodal molecular weight distribution. More preferably the multimodal polyethylene has a bimodal molecular weight distribution. The multimodality and broad molecular weight distribution of the polyethylene ensures that an attractive balance of polymer properties can be achieved. In particular it ensures that a high molecular weight polymer is achieved and hence makes the polyethylene suitable for pipe production. This is thought to be achieved because the unsupported catalyst provides easy access for ethylene to the active site of the catalyst which means that a high concentration of ethylene at the active site may be achieved. Preferably the multimodal polyethylene has a multimodal (e.g. bimodal or trimodal) composition.

The overall amount of ethylene monomer present in the multimodal polyethylene is preferably 50-99.9% wt, more preferably 50-99.5% wt, still more preferably 75-99.0% wt, e.g. 85 to 98% wt. Particularly preferably the overall amount of ethylene monomer in the multimodal polyethylene is 92-99.8% wt and more preferably 98 to 99.9% wt.

The total comonomer content of the multimodal polyethylene of the present invention is preferably 0.1-10% wt, still more preferably 0.2-5% wt and yet more preferably 0.3-3% wt. When it is stated herein that the amount of a given monomer present in a polymer is a certain amount, it is to be understood that the monomer is present in the polymer in the form of a repeat unit. The skilled man can readily determine what is the repeat unit for any given monomer. The comonomer is preferably one or more (e.g. one) α-olefin. Particularly preferably the comonomer is selected from propylene, 1-butene, 1-pentene, 4-methyl-1-pentene, 1-hexene, 1-octene and mixtures thereof. Preferably, however, the α-olefin is 1-butene.

A significant advantage of using metallocene catalyst in copolymerisation, specifically to produce polyethylene pipe, is that homogeneous comonomer incorporation in the polymer is obtained compared to Ziegler Natta and chromium catalysts. The improved comonomer incorporation property with metallocenes significantly enhances, for example, slow crack growth and rapid crack propagation behaviour of the polymer which has crucial impact on the polyethylene pipe properties.

The weight average molecular weight (Mw) of the multimodal polyethylene of the present invention is preferably at least 50,000 g/mol, more preferably 100,000-250,000 g/mol (e.g. 110,000 to 115,000 g/mol), still more preferably 130,000-225,000 g/mol and yet more preferably 140,000-200,000 g/mol. The Mn (number average molecular weight) of the multimodal polyethylene is preferably 5,000-40,000 g/mol (e.g. 7,000 to 11,000 g/mol), more preferably 18,000-40,000 g/mol, still more preferably 20,000-35,000 g/mol and yet more preferably 20,000-30,000 g/mol. The molecular weight distribution (MWD) of the multimodal polyethylene is preferably 1 to 25, more preferably 2 to 15 and still more preferably 5 to 10. These advantageous properties, enable production of multimodal polyethylene pipe according to present invention.

The multimodal polyethylene preferably has a MFR₂ of less than 3 g/10 min and more preferably less than 0.2 g/10 min. Still more preferably the multimodal polyethylene has a MFR₂ of 0.005-0.2, more preferably 0.0075-0.2, still more preferably 0.01 to 0.1 and yet more preferably 0.015 to 0.05 g/10 min. The multimodal polyethylene preferably has a MFR₅ of less than 10 g/10 min and more preferably less than 1 g/10 min. Still more preferably the multimodal polyethylene has a MFR₅ of 0.05 to 1, more preferably 0.01 to 0.9, still more preferably 0.1 to 0.8 and yet more preferably 0.3 to 0.75 g/10 min. This is an acceptable range of production of pipes, i.e. it ensures that the polyethylene may be extrusion moulded.

The multimodal polyethylene preferably has a melting temperature of 120-135° C., still more preferably 125-133° C. and yet more preferably 127-132° C.

The multimodal polyethylene preferably has a density of 920 to 980 kg/dm³. More preferably the multimodal polyethylene is a high density polyethylene (HDPE). HDPE has the advantage of having a relatively low inherent weight, yet high mechanical strength, corrosion and chemical resistance and long-term stability. Preferably the multimodal polyethylene has a density of 920-970 kg/m³, more preferably 935-963 kg/m³, still more preferably 940-960 kg/m³ and yet more preferably 945-955 kg/m³. The multimodal polyethylene, preferably in form of powder, preferably has a bulk density of 250 to 400 g/dm³, more preferably 250 to 350 g/dm³ and still more preferably 250 to 300 g/dm³.

The multimodal polyethylene of the present invention preferably has an ash content of 0 to 800 wt ppm, more preferably 0 to 600 wt ppm, still more preferably 0 to 400 wt ppm. Ash is typically metal oxides which derive from the catalyst, cocatalyst and polymer additives. With supported metallocene catalysts, typically silica or other related inorganic carriers are used. Also, the supported metallocene catalysts typically suffer from low polymerisation activity. The use of carriers combined with low polymerisation activity lead to high ash content and high local heterogeneities in the polymer. When unsupported catalysts described in the present application are used, significantly lower ash content and local heterogeneities in the polymer are obtained.

Ash is produced by heating the polymer comprising remnants of catalyst, cocatalyst and catalyst additives to high temperatures. Thus, ash level is significantly increased e.g. by use of carrier in the catalyst. Unfortunately the ash which forms can impact on the properties of polymer. Increased ash level gives increase to local heterogeneities in the polymer structure which often lead to mechanical failures in the pipe, meaning cracks and breakages, which deteriorates especially the slow crack growth properties of the pipe. They also affect the pipe appearance and performance by introducing roughness on the inner and outer surface which has effect e.g. on the flowability of liquids. Also, high ash content has effect on the electrical properties of the polymer leading to higher conductivity.

First ethylene polymer produced in first stage of polymerisation (all polymerisation processes) The first ethylene polymer is a metallocene polymer, i.e. it is prepared by metallocene catalysed polymerisation.

The first ethylene polymer present in the multimodal polyethylene may be an ethylene homopolymer or ethylene copolymer. Preferred copolymers comprise one or more (e.g. one) α-olefin comonomers. Preferred α-olefin comonomers are selected from propylene, 1-butene, 1-pentene, 4-methyl-1-pentene, 1-hexene, 1-octene and mixtures thereof. Preferably the α-olefin is 1-butene. Preferably, however, the first ethylene polymer is an ethylene homopolymer.

Preferably the first ethylene polymer is a lower molecular weight polymer than the second and if present third ethylene polymers.

The weight average molecular weight (Mw) of the first ethylene polymer is preferably 10,000-80,000 g/mol, still more preferably 15,000-60,000 g/mol and yet more preferably 20,000-45,000 g/mol, e.g. 25,000-40,000 g/mol. The Mn of the first ethylene polymer is preferably 5,000-40,000 g/mol, still more preferably 7,000-20,000 g/mol and yet more preferably 8,000-15,000 g/mol, e.g. 10,000 g/mol. The MWD (Mw/Mn) of the first ethylene polymer is preferably 1.8-5.0 still more preferably 2.0-4.0 and yet more preferably 2.3-3.5.

Preferably the first ethylene polymer has a MFR₂ of 10-1000 g/10 min, still more preferably 50-600 g/10 min, yet more preferably 150-500 g/10 min and yet more preferably 250-350 g/10 min.

Preferably the first ethylene polymer has a density of 960-975 kg/m³, more preferably 965-974 kg/m³ and still more preferably 969-972 kg/m³.

The first ethylene polymer preferably has a melting temperature of 128-135° C., still more preferably 130-134.5° C. and yet more preferably 132-134° C.

The amount of the first ethylene polymer present in the multimodal polyethylene is preferably 1-65% wt, more preferably 10-60% wt, still more preferably 30-55% wt and yet more preferably 40-50% wt, wherein % wt is based on the weight of the polyethylene.

### Second Ethylene Polymer Produced in Second Stage of Polymerisation (Two Stage Polymerisation Processes)

The second ethylene polymer is a metallocene polymer, i.e. it is prepared by metallocene catalysed polymerisation.

The second ethylene polymer present in the multimodal polyethylene may be an ethylene homopolymer or ethylene copolymer but is preferably an ethylene copolymer. Preferred copolymers comprise one or more (e.g. one) α-olefin comonomers. Preferred α-olefin comonomers are selected from propylene, 1-butene, 1-pentene, 4-methyl-1-pentene, 1-hexene, 1-octene and mixtures thereof. Preferably the α-olefin is 1-butene. Preferably the amount of α-olefin comonomer is 0.3 to 8% wt.

The weight average molecular weight (Mw) of the second ethylene polymer is preferably 150,000-700,000 g/mol, still more preferably 200,000-600,000 g/mol and yet more preferably 300,000-500,000 g/mol. The Mn of the second ethylene polymer is preferably 20,000-350,000 g/mol, still more preferably 50,000-200,000 g/mol and yet more preferably 80,000-150,000 g/mol. The MWD (Mw/Mn) of the second ethylene polymer is preferably 2-8 and still more preferably 2.5-5.

Preferably the second ethylene polymer has a MFR₂₁ of 0.3-4 g/10 min, still more preferably 0.5-3.5 g/10 min and yet more preferably 1 to 2.5 g/10 min. Preferably the second ethylene polymer has a MFR₅ of 0.02-0.04 g/10 min and still more preferably 0.025 to 0.035 g/10 min.

Preferably the second ethylene polymer has a density of 890-940 kg/m³, more preferably 900-935 kg/m³ and still more preferably 910-930 kg/m³.

The amount of the second ethylene polymer present in the multimodal polyethylene is preferably 35-99% wt, more preferably 40-85% wt, still more preferably 45-70% wt and yet more preferably 50-60% wt, wherein % wt is based on the weight of the polyethylene.

### HMW1 Polymer Produced in Three Stage Polymerisation Processes

The HMW1 polymer is a metallocene polymer, i.e. it is prepared by metallocene catalysed polymerisation.

The HMW1 polymer present in the multimodal polyethylene may be an ethylene homopolymer or ethylene copolymer but is preferably an ethylene copolymer. Preferred copolymers comprise one or more (e.g. one) α-olefin comonomers. Preferred α-olefin comonomers are selected from propylene, 1-butene, 1-pentene, 4-methyl-1-pentene, 1-hexene, 1-octene and mixtures thereof. Preferably the α-olefin is 1-butene. Preferably the amount of α-olefin comonomer is 0.3 to 2.5% wt.

The weight average molecular weight (Mw) of the HMW1 polymer is preferably 200,000-700,000 g/mol, still more preferably 250,000-600,000 g/mol and yet more preferably 300,000-500,000 g/mol. The Mn of the HMW1 polymer is preferably 25,000-350,000 g/mol, still more preferably 50,000-200,000 g/mol and yet more preferably 80,000-150,000 g/mol. The MWD (Mw/Mn) of the HMW1 polymer is preferably 2-8 and still more preferably 2.5-5.

Preferably the HMW1 polymer has a MFR₂₁ of 0.3-4 g/10 min, still more preferably 0.5-3.5 g/10 min and yet more preferably 1 to 2.5 g/10 min. Preferably the HMW1 polymer has a MFR₅ of 0.02-0.04 g/10 min and still more preferably 0.025 to 0.035 g/10 min.

Preferably the HMW1 polymer has a density of 890-930 kg/m³, more preferably 900-925 kg/m³ and still more preferably 910-920 kg/m³.

The amount of the HMW1 polymer present in the multimodal polyethylene is preferably 30-70% wt, more preferably 35-65% wt, still more preferably 40-60% wt and yet more preferably 40-50% wt, wherein % wt is based on the weight of the polyethylene.

### HMW2 Polymer Produced in Three Stage Polymerisation Processes

The HMW2 polymer is a metallocene polymer, i.e. it is prepared by metallocene catalysed polymerisation.

The HMW2 polymer present in the multimodal polyethylene may be an ethylene homopolymer or ethylene copolymer but is preferably an ethylene copolymer. Preferred copolymers comprise one or more (e.g. one) α-olefin comonomers. Preferred α-olefin comonomers are selected from propylene, 1-butene, 1-pentene, 4-methyl-1-pentene, 1-hexene, 1-octene and mixtures thereof. Preferably the α-olefin is 1-butene. Preferably the amount of α-olefin comonomer is 2 to 10% wt.

The weight average molecular weight (Mw) of the HMW2 polymer is preferably 300,000-1,000,000 g/mol, still more preferably 400,000-800,000 g/mol and yet more preferably 500,000-750,000 g/mol. The Mn of the HMW2 polymer is preferably 40,000-500,000 g/mol, still more preferably 50,000-300,000 g/mol and yet more preferably 70,000-250,000 g/mol. The MWD (Mw/Mn) of the HMW2 polymer is preferably 2-8 and still more preferably 2.5-5.

Preferably the HMW2 polymer has a MFR₂₁ of 0.0075-1 g/10 min.

Preferably the HMW2 polymer has a density of 890-925 kg/m³, more preferably 900-920 kg/m³ and still more preferably 905-915 kg/m³.

The amount of the HMW2 polymer present in the multimodal polyethylene is preferably 0.5-30% wt, more preferably 1.0-25% wt, still more preferably 1.5-15% wt and yet more preferably 1.5-9% wt, wherein % wt is based on the weight of the polyethylene.

### Downstream Processing

When the final multimodal polyethylene is obtained from a slurry reactor, the polymer is removed therefrom and the diluent preferably separated from it by flashing or filtration. The major part of the diluent and any unconverted comonomer is preferably recycled back to the polymerisation reactor(s). Preferably the polymer is then dried (e.g. to remove residues of liquids and gases from the reactor). Optionally the polymer is subjected to a deashing step, i.e. to washing with an alcohol, optionally mixed with a hydrocarbon liquid, or water. Preferably there is no deashing step.

In order that the polyethylene can be handled without difficulty, both within and downstream of the polymerisation process, the polyethylene from the reactors is preferably in a free-flowing state, preferably by having relatively large particles of high bulk density.

The polyethylene is preferably extruded and granulated into pellets. Preferably the processes from the polymerisation until the pelletisation extruder outlet are carried out under an inert (e.g. N₂) gas atmosphere.

Antioxidants are preferably added (process stabilisers and long term antioxidants) to the multimodal polyethylene. As antioxidant, all types of compounds known for this purpose may be used, such as sterically hindered or semi-hindered phenols, aromatic amines, aliphatic sterically hindered amines, organic phosphates and sulphur-containing compounds (e.g. thioethers). Other additives (antiblock, colour masterbatches, antistatics, slip agents, fillers, UV absorbers, lubricants, acid neutralisers and fluoroelastomer and other polymer processing agents) may optionally be added to the polymer.

If the multimodal polyethylene is to be used for the manufacture of pipe, a pigment (e.g. carbon black) is preferably added before extrusion. Pigments are preferably added in the form of a master batch.

Further additives (e.g. polymer processing agents or antiblock) may be added after pelletisation of the multimodal polyethylene. In this case the additives are preferably used as masterbatches and pellets mixed therewith before being, e.g. moulded into articles such as pipes.

### Applications

The multimodal polyethylene obtainable by (e.g. obtained by) a process as hereinbefore defined forms a further aspect of the invention. Preferred properties of the multimodal polyethylene are as set out above in relation to the polymerisation process.

The metallocene multimodal polyethylene comprises:
i) a multimodal molecular weight distribution;
ii) a molecular weight of at least 100,000 g/mol;
iii) a MFR₂ of less than 3, more preferably less than 0.2 g/10 min;
iv) a MFR₅ of less than 10, more preferably less than 1 g/10 min;
v) a bulk density of at least 250 g/dm³; and
vi) an ash content of less than 800 ppm wt.

Preferably the multimodal polyethylene has a Mw of 100,000-250,000 g/mol (e.g. 110,000 to 115,000 g/mol), still more preferably 130,000-225,000 g/mol and yet more preferably 140,000-200,000 g/mol.

Preferably the multimodal polyethylene has a Mn of 5000 to 40,000 g/mol (e.g. 7,000 to 11,000 g/mol), more preferably 18,000 to 40,000 g/mol, still more preferably 20,000 to 35,000 g/mol, and yet more preferably 20,000 to 30,000 g/mol.

Preferably the multimodal polyethylene has MWD of 1 to 25, preferably 2 to 15 and still more preferably 5 to 10.

Preferably the multimodal polyethylene has a MFR₂ of 0.005-0.2, more preferably 0.0075-0.2, still more preferably 0.01 to 0.1 and yet more preferably 0.015 to 0.05 g/10 min.

Preferably the multimodal polyethylene has a MFR₅ of 0.05 to 1, more preferably 0.01 to 0.9, still more preferably 0.1 to 0.8 and yet more preferably 0.3 to 0.75 g/10 min.

Preferably the multimodal polyethylene has a density of 920-970 kg/m³, more preferably 935-963 kg/m³, still more preferably 940-960 kg/m³ and yet more preferably 945-955 kg/m³.

Preferably the multimodal polyethylene, preferably in the form of powder, has a bulk density of 250 to 400 g/dm³, more preferably 250 to 350 g/dm³ and still more preferably 250 to 300 g/dm³.

Preferably the multimodal polyethylene has an ash content of 0 to 800 wt ppm, more preferably 0 to 600 wt ppm and still more preferably 0 to 400 wt ppm

The multimodal polyethylene is preferably used in extrusion and more preferably in pipe extrusion. A process for preparing a pipe comprises:
i) preparing a multimodal polyethylene by the process as hereinbefore defined; and
ii) extruding said multimodal polyethylene to produce pipe.

The multimodal polyethylene of the present invention may be used for extrusion or moulding (e.g. blow moulding or injection moulding). The multimodal polyethylene may therefore be used to make a wide range of articles including pipes, films and containers.

Preferably the multimodal polyethylene is used in pipe applications. Preferably it is used in HDPE pipes, e.g. according to PE80 or PE100 standards. The pipes may be used e.g. for water and gas distribution, sewer, wastewater, agricultural uses, slurries, chemicals etc.

The invention will now be described with reference to the following non-limiting examples and Figures wherein:

FIG. 1 is a schematic of a process of the present invention;

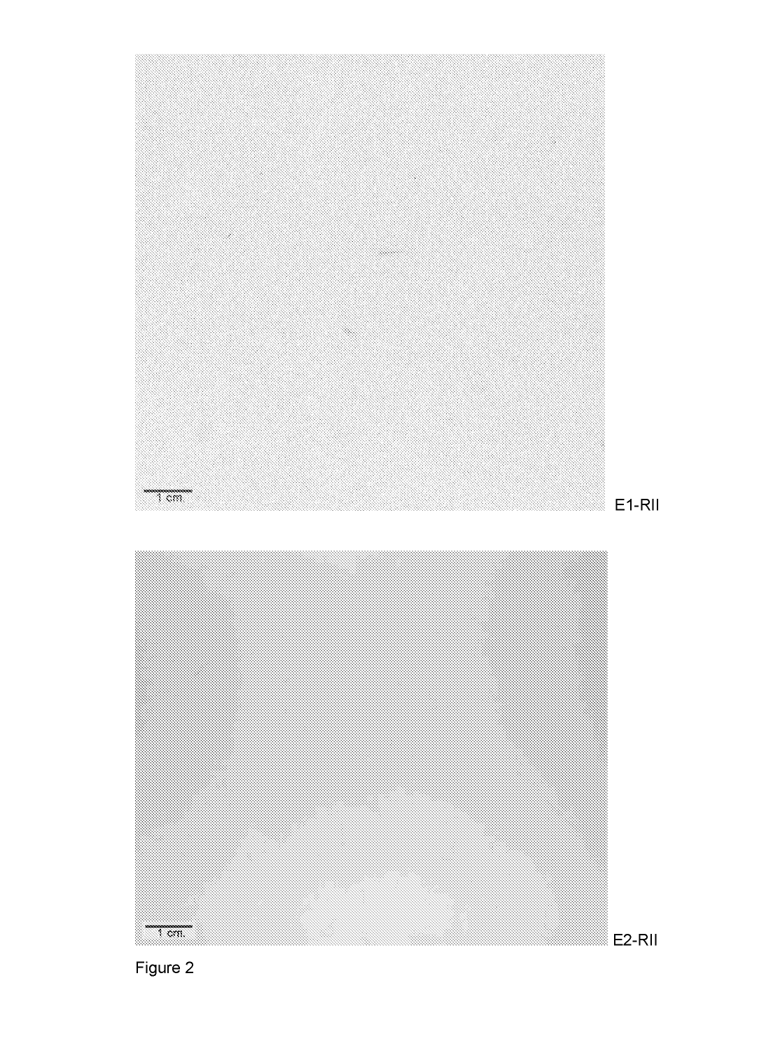

FIG. 2 shows light microscopy pictures of the pressed thin film samples from E1-RII and (top) and E2-RII (bottom); and

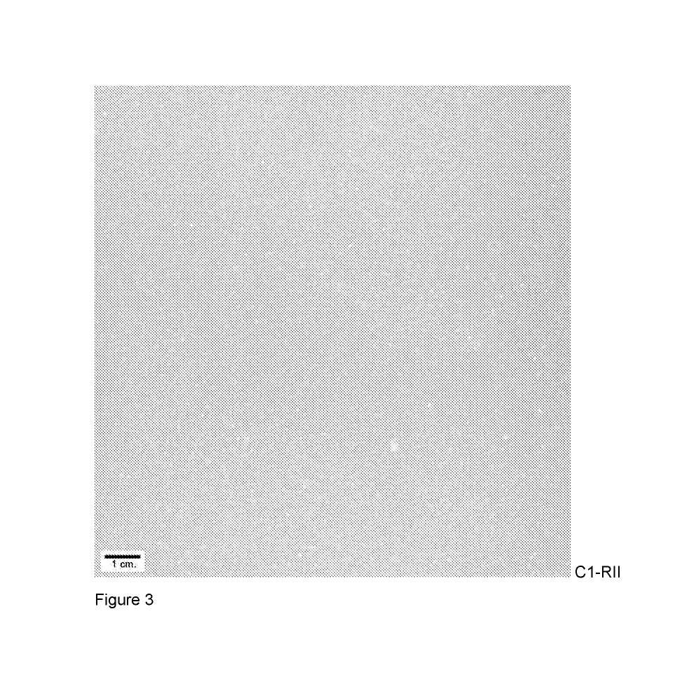

FIG. 3 shows a light microscopy picture of the pressed thin film samples from C1-RII.

### EXAMPLES

### Determination Methods for Polymers

Unless otherwise stated, the following parameters were measured on polymer samples as indicated in the Tables below.
Melt indexes (MFR₂ and MFR₅) were measured according to ISO 1133 at loads of 2.16 and 5.0 kg respectively. The measurements were at 190° C.
Molecular weights and molecular weight distribution, Mn, Mw and MWD were measured by Gel Permeation Chromatography (GPC) according to the following method: The weight average molecular weight Mw and the molecular weight distribution (MWD=Mw/Mn wherein Mn is the number average molecular weight and Mw is the weight average molecular weight) is measured by a method based on ISO 16014-4:2003. A Waters Alliance GPCV2000 instrument, equipped with refractive index detector and online viscosimeter was used with 1 PLgel GUARD+3 PLgel MIXED-B and 1,2,4-trichlorobenzene (TCB, stabilised with 250 mg/I 2,6-Di tert butyl-4-methyl-phenol) as solvent at 160° C. and at a constant flow rate of 1 ml/min. 206 μl of sample solution were injected per analysis. The column set was calibrated using universal calibration (according to ISO 16014-2:2003) with 15 narrow molecular weight distribution polystyrene (PS) standards in the range of 0.58 kg/mol to 7500 kg/mol. These standards were from Polymer Labs and had Mw/Mn from 1.02 to 1.10. Mark Houwink constants were used for polystyrene and polyethylene (K: 0.19×10⁻⁵ dl/g and a: 0.655 for PS and K: 3.9×10⁻⁴ dl/g and a: 0.725 for PE). All samples were prepared by dissolving 0.5-3.5 mg of polymer in 4 ml (at 140° C.) of stabilised TCB (same as mobile phase) and keeping for 3 hours at 140° C. and for another 1 hour at 160° C. with occasional shaking prior to sampling into the GPC instrument.
Density of materials was measured according to ISO 1183:1987 (E), method D, with isopropanol-water as gradient liquid. The cooling rate of the plaques when crystallising the samples was 15° C./min. Conditioning time was 16 hours.
Rheology of the polymers was determined by frequency sweep at 190° C. under nitrogen atmosphere according to ISO 6721-10, using Rheometrics RDA II Dynamic Rheometer with parallel plate geometry, 25 mm diameter plate and 1.2 mm gap. The measurements gave storage modulus (G′), loss modulus (G″) and complex modulus (G*) together with the complex viscosity (η*), all as a function of frequency (ω). These parameters are related as follows: For any frequency ω: The complex modulus: G*=(G′2+G″2)^{1/2}. The complex viscosity: η*=G*/ω. The denomination used for modulus is Pa (or kPa) and for viscosity is Pa s and frequency (1/s). η*_{0.05} is the complex viscosity at a frequency of 0.05 s⁻¹ and η*₂₀₀ is the complex viscosity at 200 s⁻¹. According to the empirical Cox-Merz rule, for a given polymer and temperature, the complex viscosity as a function of frequency measured by this dynamic method is the same as the viscosity as a function of shear rate for steady state flow (e.g. a capillary). Polydispersity index (PI) is the crossover point where G′=G″.
Polymerisation activity (kg PE/mol metal*h) was calculated in each polymerisation stage based on polymer yield, molar level of the metallocene complex and residence time in the reactor.
Polymerisation productivity (kg PE/mol metal) was calculated in each polymerisation stage based on polymer yield and molar level of the metallocene complex.
Total activity and total productivity are based on the polymer yields and residence times in each reactor, taking also into account the polymer samples taken out of the reactor between the different stages.
As used herein, bulk density is measured on polymer powder. The bulk density of a powder (loose bulk density) is the ratio of the mass of an untapped powder sample and its volume (g/dm³). The bulk density of a polymer powder was determined by measuring ca. 100 g of powder sample and let it flow freely through a funnel into a 100 ml cylinder with certified volume and measuring the powder weight.
Particle size of the polymer was analysed from the dry powder by using Malvern Mastersizer 2000.
For particle size distributions the median is called the d50. The d50 is defined as the diameter where half of the population lies below this value. Similarly, 90 percent of the distribution lies below the d90, and 10 percent of the population lies below the d10.
Ash content of the polymer samples was measured by heating the polymer in a microwave oven at 650° C. during 20 minutes according to ISO 3451-1.
The foreign particle content of the polymer samples was analysed using light microscopy (Leica MZ16a; Contrast mode: Transmitted light/dark field) on pressed thin film samples. The samples were prepared by melting one gram of the polymer powder and hot-pressing it to a film between two Mylar sheets, with thickness approx. 200 μm. The quantification of the foreign particles was done by image analysis on the pressed thin film samples (3.3×2.5 mm).
Al/Me is the ratio in the polymerisation (mol/mol) of aluminium in the aluminoxane to the metal ion (e.g. Zr) of the metallocene. The aluminium level is calculated from MAO and the metal level from the metallocene complex.

### Experiments and Results

### Experimental

The following unsupported single site catalysts were used in the polymerisations:

dimethylsilicon (cyclopentadienyl hexamethylindenyl) zirconium dichloride, ^{Me2}SB(Cp,I*)ZrCl₂ (Mw=483 g/mol);

methylcyclopentadienyl permethylpentalenyl zirconium chloride, Pn*ZrCp^{Me}Cl (Mw=392 g/mol).

As a reference, two supported single site catalysts were used. The catalysts were:
comparative catalyst 1: supported dimethylsilicon (cyclopentadienyl hexamethylindenyl) zirconium dichloride metallocene complex. This catalyst was synthesised according to the method described in WO93/023439.
comparative catalyst 2: supported methylcyclopentadienyl permethylpentalenyl zirconium chloride metallocene complex. This catalyst was synthesised according to the method described WO93/023439.

Polymerisations were carried out in a 3.5 litre reactor fitted with a stirrer and a temperature control system. The same comonomer feeding system was used for all runs. The procedure comprised the following steps:

### Polymerisation of Lower Molecular Weight Ethylene Polymer:

The reactor was purged with nitrogen and heated to 110° C. 1200 ml of liquid diluent was then added to the reactor and stirring started; 270 rpm. The reactor temperature was 80° C. Unsupported single site catalyst and methylaluminoxane (MAO) were then pre-contacted for 5 min and loaded into reactor with 300 ml of diluent. Ethylene and hydrogen were then fed to get a certain total pressure. Ethylene and hydrogen were then fed continuously. When a sufficient amount of powder is made, the polymerisation is stopped and the hexane is evaporated.

### Polymerisation of Higher Molecular Weight Ethylene Polymer:

1500 ml of liquid diluent was then added to the reactor and stirring started; 270 rpm. The reactor temperature was 80° C. Ethylene, hydrogen and 1-butene were then fed to get a certain total pressure. Ethylene, hydrogen and 1-butene were then fed continuously. When a sufficient amount of powder is made, the polymerisation is stopped and the hexane is evaporated.

Two comparative bimodal polymerisations were also carried out. The first comparative polymerisation (C1) was carried out in the same manner as above except that instead of using unsupported metallocene catalyst and MAO a supported catalyst with dimethylsilicon (cyclopentadienyl hexamethylindenyl) zirconium dichloride metallocene complex was used. The second comparative polymerisation (C2) was carried out in the same manner as above except that instead of using unsupported metallocene catalyst and MAO a supported catalyst was used.

Further details of the polymerisation procedure and details of the resulting polyethylene polymers are summarised in Table 1 below wherein RI refers to the polymerisation in and the product of the first reactor, RII refers to the polymerisation in the second reactor and the product of the first and second reactor together, which is the final polyethylene product.

### Results

The polymerisations carried out in example 1 (E1) and comparative example 1 (C1) are under near identical conditions and with the same catalyst except that in example 1 the catalyst is unsupported, rather than supported as in comparative example 1. The polymerisations were run without the use of hydrogen in the second stage in order to produce bimodal polymers of high MW.

A comparison of the results for example 1 and comparative example 1 in Table 1 show the following:
The use of the unsupported catalyst in the bimodal polymerisation produced polyethylene having a significantly lower ash content (750 c.f. 6930 wt ppm) than polymerisation with a supported version of the same catalyst under otherwise identical conditions.
The use of the unsupported catalyst in the bimodal polymerisation produced polyethylene having significantly lower gels than polymerisation with a supported version of the same catalyst under otherwise identical conditions.
The use of the unsupported catalyst in the bimodal polymerisation resulted in a higher total catalyst productivity than polymerisation with a supported version of the same catalyst under otherwise identical conditions (69,552 c.f. 42,900 kg PE/mol metal).
The use of the unsupported catalyst in the bimodal polymerisation surprisingly did not lead to any reactor fouling.

The polymerisations carried out in example 2 (E2) and comparative example 2 (C2) are under near identical conditions and with the same catalyst except that in example 1 the catalyst is unsupported, rather than supported as in comparative example 1. The polymerisations were run without the use of hydrogen in the second stage in order to produce bimodal polymers of high MW.

A comparison of the results for example 2 and comparative example 2 in Table 1 show the following:
The use of the unsupported catalyst in the bimodal polymerisation produced polyethylene having a significantly lower ash content (800 c.f. 12,200 wt ppm) than polymerisation with a supported version of the same catalyst under otherwise identical conditions.
The use of the unsupported catalyst in the bimodal polymerisation produced polyethylene having significantly lower gels than polymerisation with a supported version of the same catalyst under otherwise identical conditions.
The use of the unsupported catalyst in the bimodal polymerisation resulted in a higher total catalyst productivity than polymerisation with a supported version of the same catalyst under otherwise identical conditions (38,329 c.f. 30,500 kg PE/mol metal).
The use of the unsupported catalyst in the bimodal polymerisation surprisingly did not lead to any reactor fouling.

FIG. 2 shows light microscopy pictures of the pressed thin film samples from example 1 E1-RII (top) and example 2 E2-RII (bottom). It is clear from these figures that the films produced have a very high level of homogeneity.

FIG. 3 shows a light microscopy picture of the pressed thin film sample from comparative example C1-RII. It is clear from this figure that the film produced has a poor homogeneity.

A comparison of the results therefore shows that when an unsupported single site catalyst was used, no foreign particles were found on the sample plate. When a supported version of the same catalyst under otherwise identical conditions was used, a large amount of foreign particles (silica) were found with light microscopy on the sample plate.

TABLE 1

| | | Example/Run Nos. | | | | | | | |
|---|---|---|---|---|---|---|---|---|---|
| | | E1-RI | E1-RII | E2-RI | E2-RII | C1-RI | C1-RII | C2-RI | C2-RII |
| | | Catalyst type | | | | | | | |
| | | Unsupported Cat | | Unsupported Cat | | Supported Cat | | Supported Cat | |
| | | Complex type | | | | | | | |
| | | SB(Cp, I*)ZrCl₂ | | Pn*ZrCpMeCl | | SB(Cp, I*)ZrCl₂ | | Pn*ZrCpMeCl | |
| Mw of complex | g/mol | 483 | 483 | 392 | 392 | 483 | 483 | 392 | 392 |
| Al/Me | mol/mol | 1000 | 1000 | 1000 | 1000 | 1000 | 1000 | 1000 | 1000 |
| Complex amount (mg) | mg | 2.5 | 2.5 | 4.5 | 4.5 | | | | |
| Complex amount (mmol) | mmol | 0.005 | 0.005 | 0.011 | 0.011 | 0.0037 | 0.0037 | 0.0046 | 0.0046 |
| MAO amount (gram) | g | 1.025 | 1.025 | 2.272 | 2.272 | | | | |
| MAO amount (ml) | ml | 1.14 | 1.14 | 2.52 | 2.52 | | | | |
| Solid catalyst amount | mg | | | | | 1800 | 1800 | 1800 | 1800 |
| Polymerisation | | Homo | Copo | Homo | Copo | Homo | Copo | Homo | Copo |
| Temperature | ° C. | 80 | 80 | 80 | 80 | 80 | 80 | 80 | 80 |
| Total pressure | barg | 7.8 | 8.8 | 7.8 | 8.8 | 7.8 | 8.8 | 7.8 | 8.8 |
| Solvent | | hexane | hexane | hexane | hexane | hexane | hexane | hexane | hexane |
| Partial pressure of | barg | 2.8 | 2.8 | 2.8 | 2.8 | 2.8 | 2.8 | 2.8 | 2.8 |
| solvent | | | | | | | | | |
| Amount of solvent | ml | 1500 | 1500 | 1500 | 1500 | 1500 | 1500 | 1500 | 1500 |
| Stirring speed | rpm | 270 | 270 | 270 | 270 | 270 | 270 | 270 | 270 |
| Ethylene partial | barg | 5 | 6 | 5 | 6 | 5 | 6 | 5 | 6 |
| pressure | | | | | | | | | |
| Hydrogen (in C2) | ppm | 2350 | 0 | 4000 | 0 | 2280 | 0 | 3720 | 0 |
| Comonomer type | | — | 1-butene | — | 1-butene | — | 1-butene | — | 1-hexene |
| Comonomer total | ml | 0 | 36 | 0 | 56 | 0 | 28 | 0 | 25 |
| Running time | min | 22 | 29 | 15 | 26 | 15 | 14 | 15 | 40 |
| Reactor split | w % | 50 | 50 | 50 | 50 | 50 | 50 | 50 | 50 |
| Yield | g | 180 | 180 | 220 | 220 | 80 | 80 | 70 | 70 |
| Activity (mol*h) | kg | 94844 | 71950 | 76658 | 44226 | 85900 | 92000 | 61000 | 22900 |
| | PE/mol | | | | | | | | |
| | Me*h | | | | | | | | |
| Total Activity | kg | | 81826 | | 56091 | | 88800 | | 33300 |
| (mol*h) | PE/mol | | | | | | | | |
| | Me*h | | | | | | | | |
| Productivity | kg | 34776 | 34776 | 19164 | 19164 | 21500 | 21500 | 15200 | 15200 |
| (kg PE/mol Me) | PE/mol | | | | | | | | |
| | Me | | | | | | | | |
| Total Productivity | kg | | 69552 | | 38329 | | 42900 | | 30500 |
| (kg PE/mol Me) | PE/mol | | | | | | | | |
| | Me | | | | | | | | |
| POLYMER ANALYSES | | | | | | | | | |
| Density | kg/dm3 | | 954.5 | 954.9 | | | 952.1 | | 953.9 |
| MFR2.16 | | 250 | 2.9 | 250 | 1.0 | 260 | 0.38 | 200 | 0.47 |
| MFR 5 | | | 9.7 | | 2.7 | | 1.7 | | 1.3 |
| eta0.05 | | | 4582 | | 8607 | | | | |
| eta200 | | | 535 | | 585 | | | | |
| PI | | | 1.3 | | 3 | | | | |
| Mw | | | 114200 | | 110400 | | 128233 | | 170000 |
| Mn | | | 10900 | | 7300 | | 11867 | | 13160 |
| MWD | | | 10.5 | | 15.1 | | 10.8 | | 13.1 |
| d10 | μm | | 27 | | 34 | | 98 | | 31 |
| d50 | μm | | 195 | | 277 | | 165 | | 105 |
| d90 | μm | | 654 | | 863 | | 291 | | 321 |
| Bulk Density (BD) | g/dm3 | | 270 | | 270 | | 340 | | 240 |
| Melting temperature | ° C. | | 132.5 | | 132 | | 132.5 | | 132 |
| Crystallisation | ° C. | | 118 | | 115.6 | | 117.7 | | 116.5 |
| temperature | | | | | | | | | |
| Heat of Fusion | J/g | | 216 | | 222 | | 221 | | 217 |
| Crystallinity | % | | 74.5 | | 76 | | | | |
| Gel test (pressed | | | Very | | Very | | Inhomo- | | |
| plate) | | | homo- | | homo- | | geneous, | | |
| | | | geneous | | geneous | | gels | | |
| Ash content | wtppm | | 750 | | 800 | | 6930 | | 12200 |

1. A process for the preparation of a multimodal polyethylene, said multimodal polyethylene preferably having a bimodal or trimodal molecular weight distribution, comprising:
(i) polymerising ethylene and optionally an α-olefin comonomer in a first polymerisation stage to produce a first ethylene polymer; and
(ii) polymerising ethylene and optionally an α-olefin comonomer, in the presence of said first ethylene polymer, in a second polymerisation stage,
wherein said first and second polymerisation stages are carried out in the presence of an unsupported metallocene catalyst, which is a complex of a group 4 to 10 metal having at least two ligands, wherein at least one of the ligands is persubstituted and comprises a delocalised pi system of electrons,
each polymerisation stage produces at least 5% wt of said multimodal polyethylene, and
said multimodal polyethylene has a multimodal molecular weight distribution, a molecular weight of at least 50,000 g/mol and a bulk density of at least 250 g/dm³.

2. A process as claimed in claim 1, wherein at least one of the ligands in the metallocene catalyst is selected from persubstituted cyclopentadienyl, persubstituted indenyl, persubstituted pentalenyl, persubstituted hydropentalenyl or persubstituted fluorenyl, and is preferably selected from persubstituted indenyl, persubstituted pentalenyl and persubstituted hydropentalenyl.

3. A process as claimed in claim 1, wherein at least one of the ligands is selected from the ligands shown below:

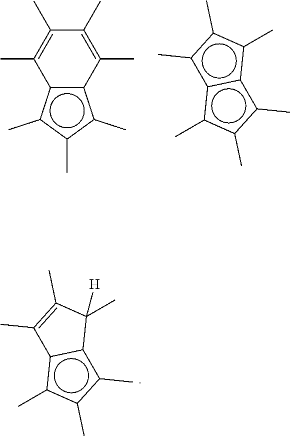

4. A process as claimed in claim 1, wherein the metallocene catalyst is a complex of a metal ion formed by a metal selected from Zr, Hf or Ti.

5. A process as claimed in claim 1, wherein the metallocene is of formula (I): 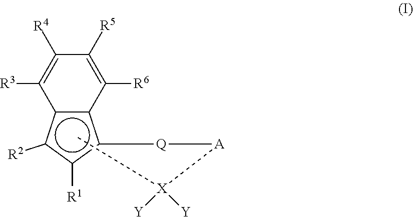
wherein
R¹, R², R³, R⁴, R⁵ and R⁶ are each independently selected from substituted or unsubstituted, preferably unsubstituted, hydrocarbyl, carbocyclyl or heterocyclyl, and preferably are each independently selected from substituted or unsubstituted, preferably unsubstituted, hydrocarbyl or carbocyclyl;
Q is a bridging group;
X is selected from Zr, Ti or Hf, and is preferably selected from Zr or Ti;
each Y is selected from halo, hydride, a phosphonated, sulfonated or borate anion, or a substituted or unsubstituted (1-6C)alkyl, (2-6C)alkenyl, (2-6C)alkynyl, (1-6C)alkoxy, aryl, aryl(1-4C)alkyl or aryloxy, or both Y groups are (1-3C)alkylene groups joined at their respective ends to a group Q such that when taken with X and Q, the two Y groups form a 4, 5 or 6 membered ring, and is preferably selected from chloro, bromo or methyl; and
A is NR′, wherein R′ is (1-6alkyl), (2-6C)alkenyl, (2-6C)alkynyl, (1-6C)alkoxy, aryl, aryl(1-4C)alkyl or aryloxy, or Cp, where Cp is a cyclic group having a delocalised system of pi electrons.

6. A process as claimed in claim 5, wherein R² is methyl or ethyl, preferably methyl, and each of R¹, R³, R⁴, R⁵ and R⁶ is methyl.

7. A process as claimed in claim 5, wherein
Q is a bridging group having the formula —[Si(Rₑ)(R_{f})]—, wherein Rₑ and R_{f} are each independently selected from methyl, ethyl, propyl, allyl or phenyl, more preferably methyl, ethyl, propyl and allyl; or
Q is a bridging group having the formula —[C(RₐR_{b})]ₙ—, wherein n is 2 or 3, and Rₐ and R_{b} are each independently hydrogen, (1-6C)alkyl or (1-6C)alkoxy.

8. (canceled)

9. A process as claimed in claim 5, wherein the metallocene is of formula (II): 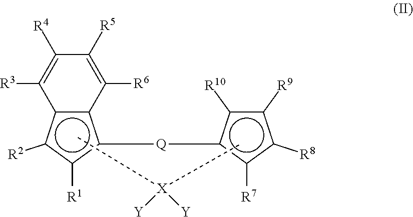
wherein
R¹, R², R³, R⁴, R⁵ and R⁶, Q, X and Y are as defined in relation to formula (I);
R⁷ and R⁸ are each independently H, substituted or unsubstituted, preferably unsubstituted, hydrocarbyl, carbocyclyl or heterocyclyl, or R⁷ and R⁸ are linked such that, when taken in combination with the atoms to which they are attached, they form a substituted or unsubstituted 6-membered fused aromatic ring;
R⁹ and R¹⁰ are each independently H, substituted or unsubstituted, preferably unsubstituted, hydrocarbyl, carbocyclyl or heterocyclyl, or R⁹ and R¹⁰ are linked such that, when taken in combination with the atoms to which they are attached, they form a substituted or unsubstituted 6-membered fused aromatic ring, and
preferably the metallocene is of formula (IIa): 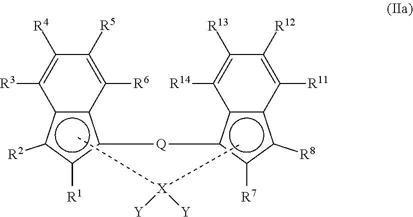
wherein
R¹, R², R³, R⁴, R⁵ and R⁶, Q, X and Y are as defined in relation to formula (I);
R⁷ and R⁸ are each independently selected from H, substituted or unsubstituted, preferably unsubstituted, hydrocarbyl, carbocyclyl or heterocyclyl;
R¹¹, R¹², R¹³ and R¹⁴ are each independently selected from H, substituted or unsubstituted, preferably unsubstituted, hydrocarbyl, carbocyclyl or heterocyclyl, or preferably the metallocene is of formulae (VIIa) or (VIIb): 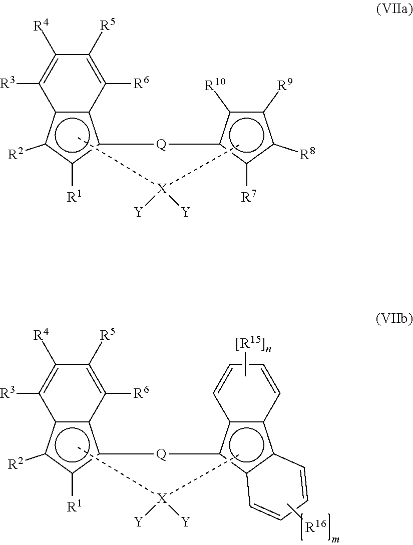
wherein
R¹, R², R³, R⁴, R⁵, R⁶, Q, X and Y are as defined in relation to formula (I);
R⁷, R⁸, R⁹ and R¹⁰ are each independently H, substituted or unsubstituted, preferably unsubstituted, hydrocarbyl, carbocyclyl or heterocyclyl;
R¹⁵ and R¹⁶ are each independently selected from hydrogen, (1-4C)alkyl and phenyl, wherein the alkyl and phenyl are optionally substituted with one or more groups selected from (1-4C)alkyl, (2-4C)alkenyl, (2-4C)alkynyl, (1-4C)alkoxy, halo, amino and nitro; and
each of n and m is independently 0, 1 or 2.

10-11. (canceled)

12. A process as claimed in claim 1, wherein the metallocene is of formula (IX): 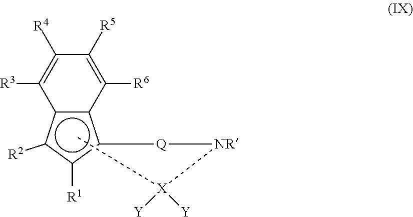
wherein
R¹, R², R³, R⁴, R⁵, R⁶, Q, X and Y are as defined in relation to formula (I); and
R¹ is (1-6alkyl).

13. A process as claimed in claim 1, wherein the metallocene is of formulae (XIa) or (XIb): 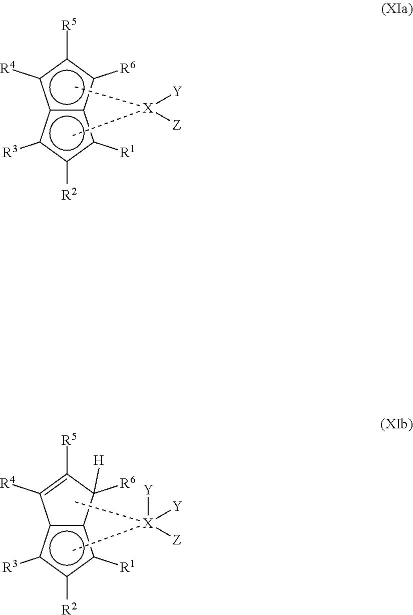
wherein
R¹, R², R³, R⁴, R⁵ and R⁶ are each independently selected from substituted or unsubstituted, preferably unsubstituted, hydrocarbyl, carbocyclyl or heterocyclyl;
X is selected from Zr, Ti or Hf;
each Y is selected from halo, hydride, a phosphonate, sulfonate or borate anion, or a substituted or unsubstituted (1-6C)alkyl, (2-6C)alkenyl, (2-6C)alkynyl, (1-6C)alkoxy, aryl, aryl(1-4C)alkyl or aryloxy, or, when present, both Y groups are (1-3C)alkylene groups joined at their respective ends to a group Q such that when taken with X and Q, the two Y groups form a 4, 5 or 6 membered ring; and
Z is Y or Cp, wherein Cp is a cyclic group having a delocalised system of pi electrons,
preferably, wherein the metallocene is of formula (XIc): 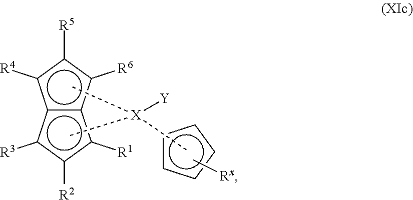
wherein
each of R¹, R², R³, R⁴, R⁵, R⁶, X and Y are as defined in relation to formula (XIa); and,
R^{x} is selected from (1-6alkyl),
or wherein the metallocene is of formula (XIf): 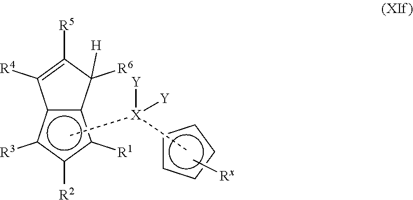
wherein
each of R¹, R², R³, R⁴, R⁵, R⁶, X and Y are as defined in relation to formula (XIb); and
R^{x} is selected from (1-6alkyl).

14-15. (canceled)

16. A process as claimed in claim 1, wherein an aluminoxane cocatalyst, preferably a mixture of an aluminoxane cocatalyst and metallocene diluted in a C₄₋₁₀ saturated alkane or toluene, is employed.

17. A process as claimed in claim 1, wherein said first polymerisation stage and/or said second polymerisation stage is in slurry conditions, preferably in slurry conditions in an aliphatic hydrocarbon diluent, and is optionally carried out in the presence of hydrogen.

18. (canceled)

19. A process as claimed in claim 1, wherein said process consists of a first polymerisation stage, which preferably produces 1 to 65% wt of said multimodal polyethylene, and a second polymerisation stage, which preferably produces 35 to 99% wt of said multimodal polyethylene.

20. A process as claimed in claim 1, wherein said process consists of a first polymerisation stage, a second polymerisation stage and a third polymerisation stage, wherein said third polymerisation stage is preferably carried out in slurry conditions.

21. A process as claimed in claim 20, comprising the sequential steps (a)-(c):
(a) polymerising ethylene and optionally an α-olefin comonomer in a first polymerisation stage to produce a lower molecular weight ethylene (LMW) polymer;
(b) polymerising ethylene and optionally an α-olefin comonomer in a second polymerisation stage to produce a first higher molecular weight ethylene polymer (HMW1); and
(c) polymerising ethylene and optionally an α-olefin comonomer in a third polymerisation stage to produce a second higher molecular weight ethylene polymer (HMW2),
or comprising the sequential steps (a1)-(c1):
(a1) polymerising ethylene and optionally an α-olefin comonomer in a first polymerisation stage to produce a lower molecular weight ethylene polymer (LMW);
(b1) polymerising ethylene and optionally an α-olefin comonomer in a second polymerisation stage to produce a second higher molecular weight ethylene polymer (HMW2); and
(c1) polymerising ethylene and optionally an α-olefin comonomer in a third polymerisation stage to produce a first higher molecular weight ethylene polymer (HMW1).

22. (canceled)

23. A process as claimed in claim 1, wherein there is no reactor fouling in said first and/or second polymerisation stage.

24. A process as claimed in claim 1, wherein said multimodal polyethylene:
has a Mw of 100,000 to 250,000 g/mol,
has a Mn of 5,000 to 40,000 g/mol,
has a MWD of 1 to 25,
has a MFR₂ of 0.005 to 3 g/10 min and more preferably 0.005 to 0.2 g/10 min,
has a MFR₅ of 0.05 to 10 g/10 min and more preferably 0.05 to 1 g/10 min,
comprises 0.5 to 10% wt comonomer,
has a density of 920 to 980 kg/dm³,
has a bulk density of 250 to 400 g/dm³,
has an ash content of 0 to 800 wt ppm, and/or
is in the form of particles.

25-33. (canceled)

34. A process as claimed in claim 1, wherein said first ethylene polymer has a MFR₂ of 130 to 300 g/10 min.

35. (canceled)

36. A metallocene multimodal polyethylene comprising:
i) a multimodal molecular weight distribution;
ii) a molecular weight of at least 50,000 g/mol;
iii) a MFR₂ of less than 3 g/10 min, more preferably less than 0.2 g/10 min;
iv) a MFR₅ of less than 10 g/10 min, more preferably less than 1 g/10 min;
v) a bulk density of at least 250 g/dm³; and
vi) an ash content of less than 800 ppm wt.

37. A process for preparing a pipe comprising:
i) preparing a multimodal polyethylene by the process claimed in claim 1; and
ii) extruding said multimodal polyethylene to produce pipe.

38. (canceled)

39. A pipe comprising metallocene multimodal polyethylene as claimed in claim 36.
